(19) United States
(12) Patent Application Publication
(10) Pub. No.: US 2026/0104598 A1
(43) Pub. Date: Apr. 16, 2026

(54) COMPOSITE CONTACT LENSES WITH ULTRATHIN OBJECTS

(71) Applicant: Alcon Inc., Fribourg (CH)

(72) Inventors: David Andrew Icenogle, Brookhaven, GA (US); Richard Charles Breitkopf, Dunwoody, GA (US)

(21) Appl. No.: 19/357,215

(22) Filed: Oct. 14, 2025

Related U.S. Application Data
(60) Provisional application No. 63/707,239, filed on Oct. 15, 2024.

(51) Int. Cl. G02C 7/04

(52) U.S. Cl. CPC G02C 7/049

(57) ABSTRACT

A contact lens may include a lens body, which includes an anterior surface, a posterior surface opposite the anterior surface, a bulk hydrogel material, and thin plastic objects partially embedded in the bulk hydrogel. Each thin plastic object is made of a crosslinked polymeric material different from the bulk hydrogel material and has a thickness of between about 0.5 micron and about 30 microns and a width or length of greater than about 2.0 mm. Each thin plastic object includes an exposed surface and a buried surface directly in contact with the bulk hydrogel material. The exposed surface merges with the anterior surface or the posterior surface and has a curvature substantially identical to the curvature of the anterior surface or the posterior surface.

This application claims the benefit under 35 USC § 119 (e) of U.S. provisional application No. 63/707,239 filed 15 Oct. 2024, incorporated by reference in its entirety.

### BACKGROUND

Traditional contact lens manufacturing methods primarily involve double-sided molding techniques, which limit the thickness of layers that can be effectively produced. Typically, these methods do not allow for generating layers thinner than 20-30 microns due to issues related to material handling and uniformity. This limitation poses significant challenges in achieving specific optical properties, reducing mechanical stress, and ensuring comfort when using multiple materials in composite contact lens construction.

### SUMMARY

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

The present disclosure is directed to composite contact lenses with ultrathin objects which are made of a polymeric material different from the lens bulk materials and are embedded completely or partially within the lens bulk materials. One general aspect includes a method for producing composite contact lenses. The method includes (1) obtaining a preformed contact lens precursor that is made of a first crosslinked polymeric material and may include a front surface and a back surface opposite the front surface, where one of the front surface and the back surface is a recess-containing surface that includes one or more recesses each of which has side walls, a bottom surface, a depth of between about 0.5 micron and about 30 microns, and a width or length of greater than about 2.0 mm. The method also includes (2) accurately and uniformly applying a polymerizable composition to the one or more recesses to fully cover each recess with a layer of the polymerizable composition in a way that a top surface of the layer merges with the recess-containing surface and has a curvature substantially identical to the curvature of the recess-containing surface. The method also includes (3) curing the polymerizable composition in the recesses to form a composite contact lens may include thin objects that are made of a second crosslinked polymeric material and has a thickness of between about 0.5 micron and about 30 microns and a width or length of greater than about 2.0 millimeters, where each thin object is partially embedded in the contact lens and may include a buried surface and an exposed surface opposite the buried surface, where the buried surface is in contact directly with the first crosslinked polymeric material whereas the exposed surface merges with an anterior surface or a posterior surface of the contact lens and has a curvature substantially identical to the curvature of the anterior surface or the posterior surface of the contact lens.

Implementations may include one or more of the following features. The method where the method further may include, between steps (2) and (3), a step of placing and pressing a capping mold half onto the recess-containing surface that may include the one or more recesses filled with the polymerizable composition therein. The preformed contact lens precursor is obtained by: dispensing a lens formulation into a mold assembly, the mold assembly includes a first mold portion (half) with a first molding surface and a second mold portion (half) with a second molding surface, where a molding cavity for holding the lens formulation is formed between the first and second molding surfaces when the first mold portion and the second mold portion are mated and pressed tightly together, where one of the first and second molding surfaces may include one or more raised portions each of which defines one of the recesses in the preformed contact lens precursor; and curing actinically or thermally the lens formulation to form the preformed contact lens precursor.

Accurately and uniformly applying the polymerizable composition to the one or more recesses may include moving a motion control platform along at least one axis to precisely control application of the polymerizable composition via an ultrasonic nozzle dispenser.

One general aspect includes a contact lens that includes a lens body that includes: an anterior surface, a posterior surface opposite the anterior surface, a bulk hydrogel material, and thin plastic objects partially embedded in the bulk hydrogel material, wherein the thin plastic objects are made of a crosslinked polymeric material different from the bulk hydrogel material and has a thickness of between about 0.5 micron and about 30 microns and a width or length of greater than about 2.0 mm, wherein each thin plastic object comprises a buried surface and an exposed surface opposite the buried surface, wherein the buried surface is in contact directly with the bulk hydrogel material whereas the exposed surface merges with the anterior surface or the posterior surface of the contact lens and has a curvature substantially identical to the curvature of the anterior surface or the posterior surface of the contact lens.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1A is a schematic diagram depicting a mold assembly used to form a preformed contact lens precursor according to an example implementation.

FIG. 1B is a schematic diagram depicting a process of making a composite contact lens according to an example implementation.

FIG. 1C is a schematic diagram depicting another mold assembly used to form a preformed contact lens precursor according to an example implementation.

FIG. 1D is a schematic diagram depicting another a process of making a composite contact lens according to an example implementation.

FIGS. 2A-2D are diagrams depicting composite contact lenses including different configurations of multiple thin plastic objects according to example implementations.

FIG. 3 is a block diagram depicting an example polymerizable composition dispensing apparatus architecture according to an example implementations.

### DETAILED DESCRIPTION

Conventional methods for manufacturing contact lenses with multiple materials and coatings face significant limitations, particularly when it comes to creating ultrathin layers (e.g., a thickness of 0.5-30 microns) with precise control. Conventional double-sided molding techniques and sequential layer application processes often result in thicker layers (e.g., greater than 30 microns), which can lead to issues such as optical distortion, mechanical stress, and discomfort for the wearer. Additionally, achieving uniformity and consistency in these ultrathin layers is challenging, and the manual intervention currently required can lead to variability and inefficiencies.

As used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another implementation includes from the one particular value and/or to the other particular value. Similarly, when values are expressed as approximations, by use of the antecedent “about,” it will be understood that the particular value forms another embodiment.

“Contact Lens” refers to a structure that can be placed on or within a wearer's eye. A contact lens can correct, improve, or alter a user's eyesight, but that need not be the case. A contact lens can be of any appropriate material known in the art or later developed, and can be a soft lens, a hard lens, or an embedded lens.

A “hydrogel contact lens” refers to a contact lens the bulk lens material of which is a hydrogel material. A hydrogel bulk material can be a non-silicone hydrogel material or preferably a silicone hydrogel material. A bulk lens material in reference to a material that constitutes at least 70% by weight of a dry contact lens (i.e., excluding water).

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated).

A “silicone hydrogel” or “SiHy” refers to a silicone-containing hydrogel obtained by copolymerization of a polymerizable composition comprising at least one silicone-containing monomer or at least one silicone-containing macromer or at least one cross linkable silicone-containing prepolymer.

A “siloxane,” which often also described as a “silicone,” refers to a moiety of —Si—O—Si— where each Si atom carries two organic groups as substituents. A polysiloxane refers to a moiety of —Si—O—(Si—O)n-Si— in which each Si atom carries two organic groups as substituents and n is an integer of 2 or greater.

As used in this application, the term “non-silicone hydrogel” or “non-silicone hydrogel material” interchangeably refers to a hydrogel that is theoretically free of silicon.

A “thin object” refers to a plastic material which has a thickness of between about 0.5 micron and about 30 microns and which is made of a crosslinked polymeric material that is different from a polymeric material in which the think object is embedded partially or fully. A think object can have any geometrical shape and can have any desired functions. Examples of preferred functional thin objects include without limitation diffractive optics objects, photochromic objects, cosmetic objects having color patterns printed thereon or therein, HEVL-blocking objects, selectively-color-filtering objects, drug delivery objects, comfort-imparting objects for delivering beneficial agents, anti-reflective objects, lubricating objects, antimicrobial objects, etc.

The term “anterior surface,” “front surface,” “front curve surface” or “FC surface” in reference to a contact lens or a preformed contact lens precursor, as used in this application, interchangeably means a surface of the contact lens or the preformed contact lens that faces away from the eye if being worn. The anterior surface (FC surface) is convex.

The “posterior surface,” “back surface,” “base curve surface” or “BC surface” in reference to a contact lens or a preformed contact lens precursor, as used in this application, interchangeably means a surface of the contact lens or the preformed contact lens precursor that faces towards the eye if being worn. The posterior surface (BC surface) is concave.

A “central axis” in reference to a contact lens or a preformed contact lens precursor, as used in this application, means an imaginary reference line passing through the geometrical centers of the anterior and posterior surfaces of a contact lens or a preformed contact lens precursor.

The term “diameter” in reference to a contact lens or a circular thin object, as used in this application, means the width of the contact lens or the circular thin object from edge to edge.

A “vinylic monomer” refers to a compound that has one sole ethylenically unsaturated group, is soluble in a solvent, and can be polymerized actinically or thermally.

As used in this application, the term “ethylenically unsaturated group” is employed herein in a broad sense and is intended to encompass any groups containing at least one >C═CH₂ group. Exemplary ethylenically unsaturated groups include without limitation (meth)acryloyl

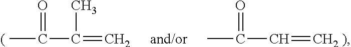

allyl, vinyl, styrenyl, or other C═CH₂ containing groups.

An “acrylic monomer” refers to a vinylic monomer having one sole (meth)acryloyl group. Examples of acrylic monomers includes (meth)acryloxy [or (meth)acryloyloxy]monomers and (meth)acrylamido monomers.

An “(meth)acryloxy monomer” or “(meth)acryloyloxy monomer” refers to a vinylic monomer having one sole group of

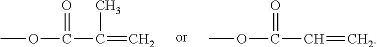

An “(meth)acrylamido monomer” refers to a vinylic monomer having one sole group of

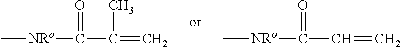

in which R^{o} is H or C₁-C₄ alkyl.

The term “aryl vinylic monomer” refers to a vinylic monomer having at least one aromatic ring.

The term “(meth)acrylamide” refers to methacrylamide and/or acrylamide.

The term “(meth)acrylate” refers to methacrylate and/or acrylate.

An “N-vinyl amide monomer” refers to an amide compound having a vinyl group (—CH═CH₂) that is directly attached to the nitrogen atom of the amide group.

An “ene monomer” refers to a vinylic monomer having one sole ene group.

A “hydrophilic vinylic monomer”, a “hydrophilic acrylic monomer”, a “hydrophilic (meth)acryloxy monomer”, or a “hydrophilic (meth)acrylamido monomer”, as used herein, respectively refers to a vinylic monomer, an acrylic monomer, a (meth)acryloxy monomer, or a (meth)acrylamido monomer), which typically yields a homopolymer that is water-soluble or can absorb at least 10 percent by weight of water.

A “hydrophobic vinylic monomer”, a “hydrophobic acrylic monomer”, a “hydrophobic (meth)acryloxy monomer”, or a “hydrophobic (meth)acrylamido monomer”, as used herein, respectively refers to a vinylic monomer, an acrylic monomer, a (meth)acryloxy monomer, or a (meth)acrylamido monomer), which typically yields a homopolymer that is insoluble in water and can absorb less than 10% by weight of water.

As used in this application, the term “vinylic crosslinker” refers to an organic compound having at least two ethylenically unsaturated groups. A “vinylic crosslinking agent” refers to a vinylic crosslinker having a molecular weight of 700 Daltons or less.

An “acrylic crosslinker” refers to a vinylic crosslinker having at least two (meth)acryloyl groups.

An “aryl vinylic crosslinker” refers to a vinylic crosslinker having at least one aromatic ring.

The term “acrylic repeating units” refers to repeating units of a polymeric material, each of which is derived from an acrylic monomer or crosslinker in a free-radical polymerization to form the polymeric material.

The term “terminal (meth)acryloyl group” refers to one (meth)acryloyl group at one of the two ends of the main chain (or backbone) of an organic compound as known to a person skilled in the art.

As used herein, “actinically” in reference to curing, crosslinking or polymerizing of a polymerizable composition, a prepolymer or a material means that the curing (e.g., crosslinked and/or polymerized) is performed by actinic irradiation, such as, for example, UV/visible irradiation, ionizing radiation (e.g. gamma ray or X-ray irradiation), microwave irradiation, and the like. Thermal curing or actinic curing methods are well-known to a person skilled in the art.

As used in this application, the term “polymer” means a material formed by polymerizing/crosslinking one or more monomers or macromers or prepolymers or combinations thereof.

A “macromer” or “prepolymer” refers to a compound or polymer that contains ethylenically unsaturated groups and has a number average molecular weight of greater than 700 Daltons.

As used in this application, the term “molecular weight” of a polymeric material (including monomeric or macromeric materials) refers to the number-average molecular weight unless otherwise specifically noted or unless testing conditions indicate otherwise. A skilled person knows how to determine the molecular weight of a polymer according to known methods, e.g., GPC (gel permeation chromatography) with one or more of a refractive index detector, a low-angle laser light scattering detector, a multi-angle laser light scattering detector, a differential viscometry detector, a UV detector, and an infrared (IR) detector; MALDI-TOF MS (matrix-assisted laser desorption/ionization time-of-flight mass spectroscopy); ¹H NMR (Proton nuclear magnetic resonance) spectroscopy, etc.

A “polysiloxane segment” or “polydiorganosiloxane segment” interchangeably refers to a polymer chain segment (i.e., a divalent radical) of

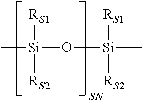

in which SN is an integer of 3 or larger and each of R_{S1} and R_{S2} independent of one another are selected from the group consisting of: C₁-C₁₀ alkyl; phenyl; C₁-C₄-alkyl-substituted phenyl; C₁-C₄-alkoxy-substituted phenyl; phenyl-C₁-C₆-alkyl; C₁-C₁₀ fluoroalkyl; C₁-C₁₀ fluoroether; aryl; aryl C₁-C₁₈ alkyl; -alk-(OC₂H₄)_{γ1}—OR^{o} (in which alk is C₁-C₆ alkylene diradical, R^{o} is H or C₁-C₄ alkyl and γ1 is an integer from 1 to 10); a C₂-C₄₀ organic radical having at least one functional group selected from the group consisting of hydroxyl group (—OH), carboxyl group (—COOH), amino group (—NR_{N1}R_{N1}′), amino linkages of —NR_{N1}—, amide linkages of —CONR_{N1}—, amide of —CONR_{N1}R_{N1}′, urethane linkages of —OCONH—, and C₁-C₄ alkoxy group, or a linear hydrophilic polymer chain, in which R_{N1} and R_{N1}′ independent of each other are hydrogen or a C₁-C₁₅ alkyl.

A “polysiloxane vinylic monomer” refers to a compound comprising at least one polysiloxane segment and one sole ethylenically-unsaturated group.

A “polydiorganosiloxane vinylic crosslinker” or polysiloxane vinylic crosslinker” interchangeably refers to a compound comprising at least one polysiloxane segment and at least two ethylenically-unsaturated groups.

The term “monovalent radical” refers to an organic radical that is obtained by removing a hydrogen atom from an organic compound and that forms one bond with one other group in an organic compound. Examples include without limitation, alkyl (by removal of a hydrogen atom from an alkane), alkoxy (or alkoxyl) (by removal of one hydrogen atom from the hydroxyl group of an alkyl alcohol), thiyl (by removal of one hydrogen atom from the thiol group of an alkylthiol), cycloalkyl (by removal of a hydrogen atom from a cycloalkane), cycloheteroalkyl (by removal of a hydrogen atom from a cycloheteroalkane), aryl (by removal of a hydrogen atom from an aromatic ring of the aromatic hydrocarbon), heteroaryl (by removal of a hydrogen atom from any ring atom), amino (by removal of one hydrogen atom from an amine), etc.

The term “divalent radical” refers to an organic radical that is obtained by removing two hydrogen atoms from an organic compound and that forms two bonds with other two groups in an organic compound. For example, an alkylene divalent radical (i.e., alkylenyl) is obtained by removal of two hydrogen atoms from an alkane, a cycloalkylene divalent radical (i.e., cycloalkylenyl) is obtained by removal of two hydrogen atoms from the cyclic ring.

In this application, the term “substituted” in reference to an alkyl or an alkylenyl means that the alkyl or the alkylenyl comprises at least one substituent which replaces one hydrogen atom of the alkyl or the alkylenyl and is selected from the group consisting of hydroxyl (—OH), carboxyl (—COOH), —NH₂, sulfhydryl (—SH), C₁-C₄ alkyl, C₁-C₄ alkoxy, C₁-C₄ alkylthio (alkyl sulfide), C₁-C₄ acylamino, C₁-C₄ alkylamino, di-C₁-C₄ alkylamino, and combinations thereof.

The present disclosure relates to composite contact lenses each with one or more ultrathin plastic objects. The present disclosure addresses several limitations of conventional contact lens manufacturing methods by introducing an advanced system that uses an ultrasonic nozzle dispenser mounted on a motion control platform which can control XYZ motion and optionally (but advantageously) C motion. The method begins with the formation of a main lens body (i.e., a preformed contact lens precursor) having one or more recesses on its front or back surface using a double-sided molding process which involve cast-molding of a lens formulation, which as known to a person skilled in the art is a polymerizable composition comprising vinylic monomers and vinylic crosslinkers for forming contact lenses), in a mold consisting typically of one male mold half and one female mold half. The female mold half has a molding surface (or a concave molding surface) defining the anterior surface of a preformed contact lens precursor to be molded whereas the male mold half has a molding surface (or a convex molding surface) defining the posterior surface of the preformed contact lens precursor to be molded. When the female and male mold halves are mated and closed tightly, a molding cavity is formed between the molding surfaces of the female and male mold halves. One of the two molding surfaces comprises one or more raised portions each of which defines one of the recesses on the anterior or posterior surface of the preformed contact lens precursor. A specific quantity of the lens formulation is dispensed onto the molding surface of one female mold half, and then the male mold half is pressed onto and closed with the female half to form a molding assembly with the lens formulation in the molding cavity. The lens formulation within the molding assembly can then be cured actinically by UV/visible lights or thermally in an oven. After the curing step, the molding assembly is opened preferably in a way that the preformed contact lens precursor is selectively adhered onto either the female mold half or the male mold half to expose the one or more recesses for further processing. The preformed contact lens precursor is composed of a first crosslinked polymeric material (also referred to herein as “a bulk lens material”) formed from curing of the lens formulation.

An ultrasonic dosing device equipped with XYZ or XYZC motion control is used, allowing for the precise deposition of the polymerizable composition with thicknesses ranging from about 0.5 to 30 microns (referred to herein as “ultrathin”). The XYZ or XYZC motion control ensures the complete coverage of each recess with a layer of the polymerizable composition in a way that a top surface of the layer merges with the recess-containing surface and has a curvature substantially identical to the curvature of the recess-containing surface. Then, the polymerizable composition in the recesses is cured actinically or thermally. Preferably, a capping mold half that conforms with the anterior or posterior surface containing the recesses is placed and pressed onto the recess-containing anterior or posterior surface and then the polymerizable composition in the recesses is cured actinically or thermally. Consequently, a composite contact lens including thin plastic objects is formed. Each thin plastic object is made of a second crosslinked polymeric material derived from the polymerizable composition and has a thickness of between about 0.5 micron and about 30 microns and a width or length of greater than about 2.0 millimeters. Each thin object is partially embedded in the composite contact lens and includes a buried surface and an exposed surface opposite the buried surface, where the buried surface is in contact directly with the first crosslinked polymeric material whereas the exposed surface merges with an anterior surface or a posterior surface of the contact lens and has a curvature substantially identical to the curvature of the anterior surface or the posterior surface of the composite contact lens. Use of a capping mold half described above could ensure that each think object could have an exposed surface with an optical quality.

It is understood that each recess may have any shape and/or pattern. Examples of shapes and/or pattern include without limitation a circle, an annular ring, an oval, a polygon (e.g., a triangle, a square, a rectangle, a pentagon, a hexagon, etc.), a series of circles arrange in a ring on a recess-containing surface, a series of polygons arrange in a ring on a recess-containing surface, combinations thereof.

In some implementations, a preformed contact lens precursor has one sole annular recess (having a shape of an annular ring) that is concentric with the central axis of the preformed contact lens precursor. Such an annular-ring-shape recess can be in the optical zone (i.e., having an outer diameter of about 7.00 mm or smaller) or outside of the optical zone on the recess-containing surface (having an inner diameter of at least 6.0 mm), depending upon the functionalities of the think plastic objects to be formed. For example, where the thin plastic object to be formed is designed for drug delivery applications, it would be advantageously located outside the optical zone of the composite contact lens so that drug administration does not interfere with the wearer's vision (e.g., blur the wearer's vision when the drug is present). As another example, where the thin plastic object to be formed is designed for adding colors to enhance or change the wearer's eye color the annular-ring shape plastic object to be formed would advantageously have an inner diameter of at least 2 mm on the FC surface of the composite contact lens.

In some implementations, a preformed contact lens precursor has one sole recess that has a shape of a circle that is concentric with the central axis of the preformed contact lens precursor and has a diameter of from about 2.0 mm to about 10.0 mm.

The recesses independent of one another can have: flat walls each of which can be at an angle normal to the recess-containing surface or at an angle of less than 60 degrees with respect to a normal line to the recess-containing surface; curved walls; or combinations thereof.

The bottom surface of a recess can be a flat surface, a curved surface, a convex surface, a concave surface, a diffractive surface comprising a diffractive structure for providing multifocal power, or combinations thereof.

In some implementations, a preformed contact lens precursor comprises a circular or annular recess which is concentric with the central axis of the preformed contact lens precursor and on the anterior or posterior surface and the bottom surface of which comprises a diffractive structure (i.e., a transmission diffractive grating) for providing multifocal power. In these implementations, a polymerizable composition comprising one or more high refractive material can be used to fill the recess. The resultant thin plastic object would have a refractive index higher than the refractive index of the first crosslinked polymeric material (i.e., lens bulk material).

As known to a person skilled in the art, a transmission diffraction grating is typically comprised of a plurality of repetitive ridges and/or grooves regularly or periodically spaced and arranged in concentrically rings or zones—annular zones (i.e., echelettes) at a respective surface of a lens (i.e., the bottom surface of a recess on the anterior or posterior surface of a preformed contact lens precursor). The periodic spacing or pitch of the ridges and/or grooves substantially determines the points of destructive and constructive interference at the optical axis of the lens. The shape and height of the ridges and/or grooves control the amount of incident light that is provided at a point of constructive interference by diffraction. The points of constructive interference are generally called diffraction orders or focal points.

The diffractive power is related to the properties of these zones, for instance their number, shape, size and position. Currently used echelettes may typically be defined by a primary zone, a secondary zone between the primary zone and a primary zone of an adjacent echelette, and an echelette geometry. The echelette geometry includes inner and outer diameters and a shaped or sloped profile. Secondary zones may describe the situation where the theoretical primary zone is a discontinuous function, leading to discrete steps in the profile height. Secondary zones may be introduced to solve the manufacturing issue of making sharp corner in a surface, and/or to reduce possible light scatter from sharp corners. The overall profile may be characterized by an echelette height or step height between adjacent echelettes. The relative radial spacing of the echelettes largely determine the power(s) of the lens and the step height of the secondary zones largely determines the light distribution between the different add powers. Together, these echelettes define a diffractive profile, often saw-toothed or stepped, on one of the surfaces of the lens.

The diffractive profile (Zdiff) (or so-called sag profile) can be given by Equation 1

$${Z}_{diff} = \frac{m λ φ ( x )}{{RI}_{2} - {RI}_{1}} {x}^{2} \qquad ( 1 )$$

in which m is the diffraction order (typically 0 for the distance focus and 1 for the ADD order), A is the design wavelength (typically 550 nm), x is radial position (i.e., the radial distance from the center), and φ(x) is a phase function in the radial x direction.

The radial position x of the diffractive transitions is a function of the diffractive optical power to be added to the system or Add power and the wavelength:

$$Zone ( i ) = \sqrt{\frac{2 i λ}{Add}} \qquad ( 2 )$$

And the height of the diffractive transition is given by:

$$Height ( i ) = \vert \frac{m λ}{{RI}_{2} - {RI}_{1}} \vert \qquad ( 3 )$$

It is understood that any phase function known to a person skilled in the art can be used in creating a desired diffractive profile. Exemplary phase functions can be a modulo 2pi kinoform design which would function as a Fresnel lens, an apodized bifocal lens design similar to ReSTOR or a Quadrafocal design similar to PanOptix which would result in a trifocal lens.

A lens formulation is any polymerizable compositions suitable for making non-silicone hydrogel materials (i.e., non-silicone hydrogel lens formulations) or preferably silicone hydrogel materials (i.e., silicone hydrogel lens formulations).

A non-silicone hydrogel lens formulation is either (1) a monomeric reaction composition comprising (a) at least one hydrophilic vinylic monomer (e.g., hydroxyl-containing vinylic monomer, N-vinylpyrrolidone, or combinations thereof) and (b) at least one component selected from the group consisting of a vinylic crosslinker, a hydrophobic vinylic monomer, a free-radical initiator (photoinitiator or thermal initiator), a UV-absorbing vinylic monomer, a high-energy-violet-light (“HEVL”) absorbing vinylic monomer, a visibility tinting agent, and combinations thereof; or (2) an aqueous solution comprising one or more water-soluble prepolymers and at least one component selected from the group consisting of hydrophilic vinylic monomer, a crosslinking agent, a hydrophobic vinylic monomer, a lubricating agent (or so-called internal wetting agents incorporated in a lens formulation), a free-radical initiator (photoinitiator or thermal initiator), a UV-absorbing vinylic monomer, a HEVL absorbing vinylic monomer, a visibility tinting agent, and combinations thereof.

Examples of water-soluble prepolymers include without limitation: a water-soluble crosslinkable poly(vinyl alcohol) prepolymer described in U.S. Pat. Nos. 5,583,163 and 6,303,687; a water-soluble vinyl group-terminated polyurethane prepolymer described in U.S. Pat. No. 6,995,192; derivatives of a polyvinyl alcohol, polyethyleneimine or polyvinylamine, which are disclosed in U.S. Pat. No. 5,849,841; a water-soluble crosslinkable polyurea prepolymer described in U.S. Pat. Nos. 6,479,587 and 7,977,430; crosslinkable polyacrylamide; crosslinkable statistical copolymers of vinyl lactam, MMA and a comonomer, which are disclosed in U.S. Pat. No. 5,712,356; crosslinkable copolymers of vinyl lactam, vinyl acetate and vinyl alcohol, which are disclosed in U.S. Pat. No. 5,665,840; polyether-polyester copolymers with crosslinkable side chains which are disclosed in U.S. Pat. No. 6,492,478; branched polyalkylene glycol-urethane prepolymers disclosed in U.S. Pat. No. 6,165,408; polyalkylene glycol-tetra(meth)acrylate prepolymers disclosed in U.S. Pat. No. 6,221,303; crosslinkable polyallylamine gluconolactone prepolymers disclosed in U.S. Pat. No. 6,472,489.

Numerous non-silicone hydrogel lens formulations have been described in numerous patents and patent applications published by the filing date of this application and have been used in producing commercial non-silicone hydrogel contact lenses. Examples of commercial non-silicone hydrogel contact lenses include, without limitation, alfafilcon A, acofilcon A, deltafilcon A, etafilcon A, focofilcon A, helfilcon A, helfilcon B, hilafilcon B, hioxifilcon A, hioxifilcon B, hioxifilcon D, methafilcon A, methafilcon B, nelfilcon A, nesofilcon A, ocufilcon A, ocufilcon B, ocufilcon C, ocufilcon D, omafilcon A, phemfilcon A, polymacon, samfilcon A, telfilcon A, tetrafilcon A, and vifilcon A. They can be used as a lens formulation.

Numerous SiHy lens formulations have been described in numerous patents and patent applications published by the filing date of this application and have been used in producing commercial SiHy contact lenses. Examples of commercial SiHy contact lenses include, without limitation, asmofilcon A, balafilcon A, comfilcon A, delefilcon A, efrofilcon A, enfilcon A, fanfilcon A, galyfilcon A, lotrafilcon A, lotrafilcon B, narafilcon A, narafilcon B, senofilcon A, senofilcon B, senofilcon C, smafilcon A, somofilcon A, and stenfilcon A. They can be used as a lens formulation.

Preferably, a SiHy lens-forming composition comprises (a) at least one silicone-containing vinylic monomer and/or at least one polysiloxane vinylic crosslinker, (b) at least one hydrophilic vinylic monomer, (c) at least one free-radical initiator, (d) at least one component selected from the group consisting of at least one non-silicone vinylic crosslinker, at least one UV-absorbing vinylic monomer, at least one HEVL-absorbing vinylic monomer, a visibility tinting agent, and combinations thereof.

Examples of preferred silicone-containing vinylic monomers include without limitation vinylic monomers each having a bis(trialkylsilyloxy)alkylsilyl group (preferably a bis(trimethylsilyloxy)-alkylsilyl group) or a tris(trialkylsilyloxy)silyl group (preferably a tris(trimethylsilyloxy)silyl group), polysiloxane vinylic monomers, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, and combinations thereof.

Examples of preferred siloxane-containing vinylic monomers each having a bis(trialkylsilyloxy)alkylsilyl group or a tris(trialkylsilyloxy)silyl group include without limitation tris(trimethylsilyloxy)-silylpropyl (meth)acrylate, [3-(meth)acryloxy-2-hydroxypropyloxy]propyl-bis(trimethylsiloxy)-methylsilane, [3-(meth)acryloxy-2-hydroxypropyloxy]propylbis(trimethyl-siloxy)butylsilane, 3-(meth)acryloxy-2-(2-hydroxyethoxy)-propyloxy)propyl-bis(trimethylsiloxy)-methylsilane, 3-(meth)acryloxy-2-hydroxypropyloxy)propyltris(trimethylsiloxy) silane, N-[tris(trimethylsiloxy)silylpropyl]-(meth)acrylamide, N-(2-hydroxy-3-(3-(bis(trimethylsilyloxy)-methylsilyl)propyloxy)-propyl)-2-methyl (meth)acrylamide, N-(2-hydroxy-3-(3-(bis(trimethyl-silyloxy)methylsilyl)propyloxy)propyl) (meth)acrylamide, N-(2-hydroxy-3-(3-(tris(trimethyl-silyloxy)silyl)propyloxy)-propyl)-2-methyl acrylamide, N-(2-hydroxy-3-(3-(tris(trimethylsilyloxy)-silyl)propyloxy)propyl) (meth)acrylamide, N-[tris(dimethylpropylsiloxy)-silylpropyl]-(meth)acrylamide, N-[tris(dimethylphenylsiloxy)silylpropyl](meth)acrylamide, N-[tris(dimethyl-ethylsiloxy)silylpropyl](meth)acrylamide, N,N-bis[2-hydroxy-3-(3-(bis(trimethylsilyloxy)-methylsilyl)propyloxy)propyl]-2-methyl (meth)acrylamide, N,N-bis[2-hydroxy-3-(3-(bis(trimethyl-silyloxy)methylsilyl)propyloxy)-propyl](meth)acrylamide, N,N-bis[2-hydroxy-3-(3-(tris(trimethyl-silyloxy)silyl)propyloxy)propyl]-2-methyl (meth)acrylamide, N,N-bis[2-hydroxy-3-(3-(tris(trimethyl-silyloxy)silyl)propyloxy)propyl](meth)acrylamide, N-[2-hydroxy-3-(3-(t-butyldimethylsilyl)-propyloxy)propyl]-2-methyl (meth)acrylamide, N-[2-hydroxy-3-(3-(t-butyldimethylsilyl)propyloxy)-propyl](meth)acrylamide, N,N-bis[2-hydroxy-3-(3-(t-butyldimethylsilyl)propyloxy)propyl]-2-methyl (meth)acrylamide, N-2-(meth)acryloxyethyl-O-(methyl-bis-trimethylsiloxy-3-propyl)silyl carbamate, 3-(trimethylsilyl)propylvinyl carbonate, 3-(vinyloxycarbonylthio)propyl-tris(trimethyl-siloxy)silane, 3-[tris(trimethylsiloxy)silyl]propylvinyl carbamate, 3-[tris(trimethylsiloxy)silyl]propyl allyl carbamate, 3-[tris(trimethylsiloxy)silyl]propyl vinyl carbonate, those disclosed in U.S. Pat. Nos. 9,097,840, 9,103,965 and 9,475,827 (herein incorporated by references in their entireties), and mixtures thereof. The above preferred silicone-containing vinylic monomers can be obtained from commercial suppliers or can be prepared according to procedures described in U.S. Pat. Nos. 5,070,215, 6,166,236, 6,867,245, 7,214,809, 8,415,405, 8,475,529, 8,614,261, 8,658,748, 9,097,840, 9,103,965, 9,217,813, 9,315,669, and 9,475,827.

Examples of preferred polysiloxane vinylic monomers include without limitation mono-(meth)acryloyl-terminated, monoalkyl-terminated polysiloxanes include without limitation α-(meth)acryloxypropyl terminated ω-butyl (or ω-methyl) terminated polydimethylsiloxane, α-(meth)acryloxy-2-hydroxypropyloxypropyl terminated ω-butyl (or ω-methyl) terminated polydimethylsiloxane, α-(2-hydroxyl-methacryloxypropyloxypropyl)-ω-butyl-decamethylpentasiloxane, α-[3-(meth)acryloxyethoxy-2-hydroxypropyloxypropyl]-terminated ω-butyl (or ω-methyl) terminated polydimethylsiloxane, α-[3-(meth)acryloxy-propyloxy-2-hydroxypropyloxypropyl]-terminated ω-butyl (or ω-methyl) terminated polydimethylsiloxane, α-[3-(meth)acryloxyisopropyloxy-2-hydroxypropyloxypropyl]-terminated ω-butyl (or ω-methyl) terminated polydimethylsiloxane, α-[3-(meth)acryloxybutyloxy-2-hydroxypropyloxypropyl]-terminated ω-butyl (or ω-methyl) terminated polydimethylsiloxane, α-[3-(meth)acryloxy-ethylamino-2-hydroxypropyloxypropyl]-terminated ω-butyl (or ω-methyl) terminated polydimethylsiloxane, α-[3-(meth)acryloxypropylamino-2-hydroxypropyloxypropyl]-terminated ω-butyl (or ω-methyl) terminated polydimethylsiloxane, α-[3-(meth)acryloxy-butylamino-2-hydroxypropyloxypropyl]-terminated ω-butyl (or ω-methyl) terminated polydimethylsiloxane, α-(meth)acryloxy(polyethylenoxy)-2-hydroxypropyloxypropyl]-terminated ω-butyl (or ω-methyl) terminated polydimethylsiloxane, α-[(meth)acryloxy-2-hydroxypropyloxy-ethoxypropyl]-terminated ω-butyl (or ω-methyl) terminated polydimethylsiloxane, α-[(meth)acryloxy-2-hydroxypropyl-N-ethylaminopropyl]-terminated ω-butyl (or ω-methyl) terminated polydimethylsiloxane, α-[(meth)acryloxy-2-hydroxypropyl-aminopropyl]-terminated ω-butyl (or w-methyl) terminated polydimethylsiloxane, α-[(meth)acryloxy-2-hydroxypropyloxy-(polyethylenoxy)propyl]-terminated ω-butyl (or ω-methyl) terminated polydimethylsiloxane, α-(meth)acryloylamidopropyloxypropyl terminated ω-butyl (or ω-methyl) terminated polydimethylsiloxane, α-N-methyl-(meth)acryloylamidopropyloxypropyl terminated ω-butyl (or w-methyl) terminated polydimethylsiloxane, α-[3-(meth)acrylamidoethoxy-2-hydroxypropyloxy-propyl]-terminated ω-butyl (or ω-methyl) polydimethylsiloxane, α-[3-(meth)acrylamido-propyloxy-2-hydroxypropyloxypropyl]-terminated ω-butyl (or ω-methyl) terminated polydimethylsiloxane, α-[3-(meth)acrylamidoisopropyloxy-2-hydroxypropyloxypropyl]-terminated ω-butyl (or ω-methyl) terminated polydimethylsiloxane, α-[3-(meth)acrylamido-butyloxy-2-hydroxypropyloxypropyl]-terminated ω-butyl (or ω-methyl) terminated polydimethylsiloxane, α-[3-(meth)acryloylamido-2-hydroxypropyloxypropyl]terminated ω-butyl (or ω-methyl) polydimethylsiloxane, α-[3-[N-methyl-(meth)acryloylamido]-2-hydroxypropyloxy-propyl]terminated ω-butyl (or ω-methyl) terminated polydimethylsiloxane, N-methyl-N′-(propyl-tetra(dimethylsiloxy)dimethylbutylsilane) (meth)acrylamide, N-(2,3-dihydroxypropane)-N′-(propyltetra(dimethylsiloxy)dimethylbutylsilane) (meth)acrylamide, (meth)acryloylamido-propyltetra(dimethylsiloxy)dimethylbutylsilane, mono-vinyl carbonate-terminated mono-alkyl-terminated polydimethylsiloxanes, mono-vinyl carbamate-terminated mono-alkyl-terminated polydimethylsiloxane, those disclosed in U.S. Pat. Nos. 9,097,840 and 9,103,965, and mixtures thereof. The above preferred polysiloxanes vinylic monomers can be obtained from commercial suppliers (e.g., Shin-Etsu, Gelest, etc.) or prepared according to procedures described in patents, e.g., U.S. Pat. Appl. Pub. Nos. 6166236, 6867245, 8415405, 8475529, 8614261, 9217813, and 9315669, or by reacting a hydroxyalkyl (meth)acrylate or (meth)acrylamide or a (meth)acryloxypolyethylene glycol with a mono-epoxypropyloxypropyl-terminated polydimethylsiloxane, by reacting glycidyl (meth)acrylate with a mono-carbinol-terminated polydimethylsiloxane, a mono-aminopropyl-terminated polydimethylsiloxane, or a mono-ethylaminopropyl-terminated polydimethylsiloxane, or by reacting isocyanatoethyl (meth)acrylate with a mono-carbinol-terminated polydimethylsiloxane according to coupling reactions well known to a person skilled in the art.

Examples of preferred polysiloxane vinylic crosslinkers include without limitation α,ω-(meth)acryloxy-terminated polydimethylsiloxanes of various molecular weight; α,ω-(meth)acrylamido-terminated polydimethylsiloxanes of various molecular weight; α,ω-vinyl carbonate-terminated polydimethylsiloxanes of various molecular weight; α,ω-vinyl carbamate-terminated polydimethylsiloxane of various molecular weight; bis-3-methacryloxy-2-hydroxypropyloxypropyl polydimethylsiloxane of various molecular weight; N,N,N′,N′-tetrakis(3-methacryloxy-2-hydroxypropyl)-alpha,omega-bis-3-aminopropyl-polydimethylsiloxane of various molecular weight; the reaction products of glycidyl methacrylate with diamino-terminated polysiloxanes; the reaction products of glycidyl methacrylate with dihydroxyl-terminated polysiloxanes; the reaction products of an azlactone-containing vinylic monomer (any one of those described above) with di-hydroxyl-terminated polydimethylsiloxanes; the reaction products of isocyantoethyl (meth)acrylate with di-hydroxyl-terminated polydimethylsiloxanes; the reaction products of isocyantoethyl (meth)acrylate with diamino-terminated polydimethylsiloxanes; polysiloxane-containing macromer selected from the group consisting of Macromer A, Macromer B, Macromer C, and Macromer D described in U.S. Pat. No. 5,760,100; polysiloxane vinylic crosslinkers disclosed in U.S. Pat. Nos. 4,136,250, 4,153,641, 4,182,822, 4,189,546, 4,259,467, 4,260,725, 4,261,875, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,449,729, 5,451,617, 5,486,579, 5,962,548, 5,981,675, 6,039,913, 6,762,264, 7,423,074, 8,163,206, 8,480,227, 8,529,057, 8,835,525, 8,993,651, 9,187,601, 10081697, 10301451, and 10465047.

One class of preferred polysiloxane vinylic crosslinkers are vinylic crosslinkers which are prepared by: reacting glycidyl (meth)acrylate or (meth)acryloyl chloride with a di-amino-terminated polydimethylsiloxane or a di-hydroxyl-terminated polydimethylsiloxane; reacting isocyantoethyl (meth)acrylate with di-hydroxyl-terminated polydimethylsiloxanes; reacting an amino-containing acrylic monomer with di-carboxyl-terminated polydimethylsiloxane in the presence of a coupling agent (a carbodiimide); reacting a carboxyl-containing acrylic monomer with di-amino-terminated polydimethylsiloxane in the presence of a coupling agent (a carbodiimide); or reacting a hydroxyl-containing acrylic monomer with a di-hydroxy-terminated polydisiloxane in the presence of a diisocyanate or di-epoxy coupling agent.

Examples of such preferred polysiloxane vinylic crosslinkers are α,ω-bis[3-(meth)acrylamidopropyl]-terminated polydimethylsiloxane, α,ω-bis[3-(meth)acryloxypropyl]-terminated polydimethylsiloxane, α,ω-bis[3-(meth)acryloxy-2-hydroxypropyloxypropyl]-terminated polydimethylsiloxane, α,ω-bis[3-(meth)acryloxyethoxy-2-hydroxypropyloxypropyl]-terminated polydimethylsiloxane, α,ω-bis[3-(meth)acryloxypropyloxy-2-hydroxypropyloxypropyl]-terminated polydimethylsiloxane, α,ω-bis[3-(meth)acryloxy-isopropyloxy-2-hydroxypropyloxy-propyl]-terminated polydimethylsiloxane, α,ω-bis[3-(meth)acryloxybutyloxy-2-hydroxypropyloxy-propyl]-terminated polydimethylsiloxane, α,ω-bis[3-(meth)acrylamidoethoxy-2-hydroxypropyloxy-propyl]-terminated polydimethylsiloxane, α,ω-bis[3-(meth)acrylamidopropyloxy-2-hydroxy-propyloxypropyl]-terminated polydimethylsiloxane, α,ω-bis[3-(meth)acrylamidoisopropyloxy-2-hydroxypropyloxypropyl]-terminated polydimethylsiloxane, α,ω-bis[3-(meth)acrylamidobutyloxy-2-hydroxypropyloxypropyl]-terminated polydimethylsiloxane, α,ω-bis[3-(meth)acryloxyethyl-amino-2-hydroxypropyloxypropyl]-terminated polydimethylsiloxane, α,ω-bis[3-(meth)acryloxy-propylamino-2-hydroxypropyloxypropyl]-terminated polydimethylsiloxane, α,ω-bis[3-(meth)acryloxybutylamino-2-hydroxypropyloxypropyl]-terminated polydimethylsiloxane, α,ω-bis[(meth)acrylamidoethylamino-2-hydroxypropyloxy-propyl]-terminated polydimethylsiloxane, α,ω-bis[3-(meth)acrylamidopropylamino-2-hydroxypropyloxypropyl]-terminated polydimethylsiloxane, α,ω-bis[3-(meth)acrylamide-butylamino-2-hydroxypropyloxypropyl]-terminated polydimethylsiloxane, α,ω-bis[(meth)acryloxy-2-hydroxypropyloxy-ethoxypropyl]-terminated polydimethylsiloxane, α,ω-bis[(meth)acryloxy-2-hydroxypropyl-N-ethylaminopropyl]-terminated polydimethylsiloxane, α,ω-bis[(meth)acryloxy-2-hydroxypropyl-aminopropyl]-polydimethylsiloxane, α,ω-bis[(meth)acryloxy-2-hydroxypropyloxy-(polyethylenoxy)propyl]-terminated polydimethylsiloxane, α,ω-bis[(meth)acryloxyethylamino-carbonyloxy-ethoxypropyl]-terminated polydimethylsiloxane, α,ω-bis[(meth)acryloxyethylamino-carbonyloxy-(polyethylenoxy)propyl]-terminated polydimethylsiloxane, and combinations thereof.

Another class of preferred polysiloxane vinylic crosslinkers are chain-extended polysiloxane vinylic crosslinkers each of which comprises at least two polysiloxane segments and can be prepared according to the procedures described in U.S. Pat. Nos. 5,034,461, 5,416,132, 5,449,729, 5,760,100, 7,423,074, 8,529,057, 8,835,525, 8,993,651, and 10301451 and in U.S. Pat. App. Pub. No. 2018-0100038 A1.

A further class of preferred polysiloxane vinylic crosslinkers are hydrophilized polysiloxane vinylic crosslinkers that each comprise at least about 1.50 (preferably at least about 2.0, more preferably at least about 2.5, even more preferably at least about 3.0) milliequivalent/gram (“meq/g”) of hydrophilic moieties, which preferably are hydroxyl groups (—OH), carboxyl groups (—COOH), amino groups (—NHR_{N1} in which R_{N1} is H or C₁-C₂ alkyl), amide moieties (—CO—NR_{N1}R_{N2} in which R_{N1} is H or C₁-C₂ alkyl and R_{N2} is a covalent bond, H, or C₁-C₂ alkyl), N—C₁-C₃ acylamino groups, urethane moieties (—NH—CO—O—), urea moieties (—NH—CO—NH—), a polyethylene glycol chain of

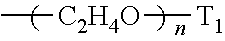

in which n is an integer of 2 to 20 and T₁ is H, methyl or acetyl or a phosphorylcholin group, or combinations thereof. U.S. patent Ser. No. 10/081,697 and U.S. Pat. Appl. Pub. No. 2022/0251302 A1 disclose hydrophilized polysiloxane vinylic crosslinkers which each comprise (1) a polydiorganosiloxane polymer chain comprising dimethylsiloxane units and hydrophilized siloxane unit having one methyl substituent and one hydrophilized organic substituent having two to six hydroxyl groups or phosphorylcholine moiety.

Any hydrophilic vinylic monomers can be used in the invention. Examples of preferred hydrophilic vinylic monomers are alkyl (meth)acrylamides (as described later in this application), hydroxyl-containing acrylic monomers (as described below), amino-containing acrylic monomers (as described later in this application), carboxyl-containing acrylic monomers (as described later in this application), N-vinyl amide monomers (as described later in this application), methylene-containing pyrrolidone monomers (i.e., pyrrolidone derivatives each having a methylene group connected to the pyrrolidone ring at 3- or 5-position) (as described later in this application), acrylic monomers having a C₁-C₄ alkoxyethoxy group (as described later in this application), vinyl ether monomers (as described later in this application), allyl ether monomers (as described later in this application), phosphorylcholine-containing vinylic monomers (as described later in this application), N-2-hydroxyethyl vinyl carbamate, N-carboxyvinyl-β-alanine (VINAL), N-carboxyvinyl-α-alanine, and combinations thereof.

Examples of alkyl (meth)acrylamides include without limitation (meth)acrylamide, N,N-dimethyl (meth)acrylamide, N-methyl (meth)acrylamide, N-ethyl (meth)acrylamide, N,N-diethyl (meth)acrylamide, N-propyl (meth)acrylamide, N-isopropyl (meth)acrylamide, N-3-methoxypropyl (meth)acrylamide, and combinations thereof.

Examples of hydroxyl-containing acrylic monomers include without limitation N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, N-tris(hydroxymethyl)methyl (meth)acrylamide, 2-hydroxyethyl (meth)acrylate, 3-hydroxypropyl (meth)acrylate, 2-hydroxypropyl (meth)acrylate, glycerol methacrylate (GMA), di(ethylene glycol) (meth)acrylate, tri(ethylene glycol) (meth)acrylate, tetra(ethylene glycol) (meth)acrylate, poly(ethylene glycol) (meth)acrylate having a number average molecular weight of up to 1500, poly(ethylene glycol)ethyl (meth)acrylamide having a number average molecular weight of up to 1500, and combinations thereof.

Examples of carboxyl-containing acrylic monomers include without limitation 2-(meth)acrylamidoglycolic acid, (meth)acrylic acid, ethylacrylic acid, 3-(meth)acrylamido-propionic acid, 5-(meth)acrylamidopentanoic acid, 4-(meth)acrylamidobutanoic acid, 3-(meth)acrylamido-2-methylbutanoic acid, 3-(meth)acrylamido-3-methylbutanoic acid, 2-(meth)acrylamido-2methyl-3,3-dimethyl butanoic acid, 3-(meth)acrylamidohaxanoic acid, 4-(meth)acrylamido-3,3-dimethylhexanoic acid, and combinations thereof.

Examples of amino-containing acrylic monomers include without limitation N-2-aminoethyl (meth)acrylamide, N-2-methylaminoethyl (meth)acrylamide, N-2-ethylaminoethyl (meth)acrylamide, N-2-dimethylaminoethyl (meth)acrylamide, N-3-aminopropyl (meth)acrylamide, N-3-methylaminopropyl (meth)acrylamide, N-3-dimethylaminopropyl (meth)acrylamide, 2-aminoethyl (meth)acrylate, 2-methylaminoethyl (meth)acrylate, 2-ethylaminoethyl (meth)acrylate, 3-aminopropyl (meth)acrylate, 3-methylaminopropyl (meth)acrylate, 3-ethylaminopropyl (meth)acrylate, 3-amino-2-hydroxypropyl (meth)acrylate, trimethylammonium 2-hydroxy propyl (meth)acrylate hydrochloride, dimethylaminoethyl (meth)acrylate, and combinations thereof.

Examples of N-vinyl amide monomers include without limitation N-vinylpyrrolidone (aka, N-vinyl-2-pyrrolidone), N-vinyl-3-methyl-2-pyrrolidone, N-vinyl-4-methyl-2-pyrrolidone, N-vinyl-5-methyl-2-pyrrolidone, N-vinyl-6-methyl-2-pyrrolidone, N-vinyl-3-ethyl-2-pyrrolidone, N-vinyl-4,5-dimethyl-2-pyrrolidone, N-vinyl-5,5-dimethyl-2-pyrrolidone, N-vinyl-3,3,5-trimethyl-2-pyrrolidone, N-vinyl piperidone (aka, N-vinyl-2-piperidone), N-vinyl-3-methyl-2-piperidone, N-vinyl-4-methyl-2-piperidone, N-vinyl-5-methyl-2-piperidone, N-vinyl-6-methyl-2-piperidone, N-vinyl-6-ethyl-2-piperidone, N-vinyl-3,5-dimethyl-2-piperidone, N-vinyl-4,4-dimethyl-2-piperidone, N-vinyl caprolactam (aka, N-vinyl-2-caprolactam), N-vinyl-3-methyl-2-caprolactam, N-vinyl-4-methyl-2-caprolactam, N-vinyl-7-methyl-2-caprolactam, N-vinyl-7-ethyl-2-caprolactam, N-vinyl-3,5-dimethyl-2-caprolactam, N-vinyl-4,6-dimethyl-2-caprolactam, N-vinyl-3,5,7-trimethyl-2-caprolactam, N-vinyl-N-methyl acetamide, N-vinyl formamide, N-vinyl acetamide, N-vinyl isopropylamide, N-vinyl-N-ethyl acetamide, N-vinyl-N-ethyl formamide, and mixtures thereof.

Examples of methylene-containing pyrrolidone monomers include without limitation 1-methyl-3-methylene-2-pyrrolidone, 1-ethyl-3-methylene-2-pyrrolidone, 1-methyl-5-methylene-2-pyrrolidone, 1-ethyl-5-methylene-2-pyrrolidone, 5-methyl-3-methylene-2-pyrrolidone, 5-ethyl-3-methylene-2-pyrrolidone, 1-n-propyl-3-methylene-2-pyrrolidone, 1-n-propyl-5-methylene-2-pyrrolidone, 1-isopropyl-3-methylene-2-pyrrolidone, 1-isopropyl-5-methylene-2-pyrrolidone, 1-n-butyl-3-methylene-2-pyrrolidone, 1-tert-butyl-3-methylene-2-pyrrolidone, and mixtures thereof.

Examples of acrylic monomers having a C₁-C₄ alkoxyethoxy group include without limitation ethylene glycol methyl ether (meth)acrylate, di(ethylene glycol) methyl ether (meth)acrylate, tri(ethylene glycol) methyl ether (meth)acrylate, tetra(ethylene glycol) methyl ether (meth)acrylate, C₁-C₄-alkoxy poly(ethylene glycol) (meth)acrylate having a number average molecular weight of up to 1500, methoxy-poly(ethylene glycol)ethyl (meth)acrylamide having a number average molecular weight of up to 1500, and combinations thereof.

Examples of vinyl ether monomers include without limitation ethylene glycol monovinyl ether, di(ethylene glycol) monovinyl ether, tri(ethylene glycol) monovinyl ether, tetra(ethylene glycol) monovinyl ether, poly(ethylene glycol) monovinyl ether, ethylene glycol methyl vinyl ether, di(ethylene glycol) methyl vinyl ether, tri(ethylene glycol) methyl vinyl ether, tetra(ethylene glycol) methyl vinyl ether, poly(ethylene glycol) methyl vinyl ether, and combinations thereof.

Examples of allyl ether monomers include without limitation ethylene glycol monoallyl ether, di(ethylene glycol) monoallyl ether, tri(ethylene glycol) monoallyl ether, tetra(ethylene glycol) monoallyl ether, poly(ethylene glycol) monoallyl ether, ethylene glycol methyl allyl ether, di(ethylene glycol) methyl allyl ether, tri(ethylene glycol) methyl allyl ether, tetra(ethylene glycol) methyl allyl ether, poly(ethylene glycol) methyl allyl ether, and combinations thereof.

Examples of phosphorylcholine-containing vinylic monomers include without limitation (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)-ethylphosphate, 3-[(meth)acryloylamino]-propyl-2′-(trimethylammonio)-ethylphosphate, 4-[(meth)acryloylamino]butyl-2′-(trimethyl-ammonio)ethylphosphate, 5-((meth)acryloyloxy)pentyl-2′-(trimethylammonio)ethyl phosphate, 6-((meth)acryloyloxy)hexyl-2′-(trimethylammonio)-ethylphosphate, 2-((meth)acryloyloxy)ethyl-2′-(triethylammonio)ethyl-phosphate, 2-((meth)acryloyloxy)ethyl-2′-(tripropylammonio)ethylphosphate, 2-((meth)acryloxy)-ethyl-2′-(tributylammonio)ethyl phosphate, 2-((meth)acryloyloxy)propyl-2′-(trimethylammonio)-ethylphosphate, 2-((meth)acryloyloxy)butyl-2′-(trimethylammonio)ethylphosphate, 2-((meth)acryloxy)pentyl-2′-(trimethylammonio)ethylphosphate, 2-((meth)acryloyloxy)hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)ethyl-phosphate, 2-(vinylcarbonylamino)ethyl-2′-(trimethylammonio)ethylphosphate, 2-(allyloxycarbonylamino)-ethyl-2′-(trimethylammonio)ethyl phosphate, 2-(butenoyloxy)ethyl-2′-(trimethylammonio)-ethylphosphate, and combinations thereof.

In accordance with the invention, the SiHy lens-forming composition can also comprise one or more hydrophobic non-silicone vinylic monomers. Examples of preferred hydrophobic non-silicone vinylic monomers can be non-silicone hydrophobic acrylic monomers (methyl (meth)acrylate, ethyl (meth)acrylate, propyl (meth)acrylate, isopropyl (meth)acrylate, cyclohexyl (meth)acrylate, 2-ethylhexyl (meth)acrylate, isobornyl (meth)acrylate, (meth)acrylonitrile, etc.), fluorine-containing acrylic monomers (e.g., perfluorohexylethyl-thio-carbonyl-aminoethyl-methacrylate, perfluoro-substituted-C₂-C₁₂ alkyl (meth)acrylates described below, etc.), vinyl alkanoates (e.g., vinyl acetate, vinyl propionate, vinyl butyrate, vinyl valerate, etc.), vinyloxyalkanes (e.g., vinyl ethyl ether, propyl vinyl ether, n-butyl vinyl ether, isobutyl vinyl ether, cyclohexyl vinyl ether, t-butyl vinyl ether, etc.), styrene, vinyl toluene, vinyl chloride, vinylidene chloride, 1-butene, and combinations thereof.

Any suitable perfluoro-substituted-C₂-C₁₂ alkyl (meth)acrylates can be used in the invention. Examples of perfluoro-substituted-C₂-C₁₂ alkyl (meth)acrylates include without limitation 2,2,2-trifluoroethyl (meth)acrylate, tetrafluoropropyl (meth)acrylate, hexafluoro-isopropyl (meth)acrylate, hexafluorobutyl (meth)acrylate, heptafluorobutyl (meth)acrylate, octafluoropentyl (meth)acrylate, heptadecafluorodecyl (meth)acrylate, pentafluorophenyl (meth)acrylate, and combinations thereof.

In accordance with the invention, the SiHy lens-forming composition can also comprise one or more non-silicone vinylic crosslinkers (free of aryl group). Examples of preferred non-silicone vinylic cross-linking agents include without limitation: acrylic crosslinkers (free of aryl group) as described above, allyl methacrylate, allyl acrylate, N-allyl-methacrylamide, N-allyl-acrylamide, tetraethyleneglycol divinyl ether, triethyleneglycol divinyl ether, diethyleneglycol divinyl ether, ethyleneglycol divinyl ether, triallyl isocyanurate, 2,4,6-triallyloxy-1,3,5-triazine, 1,2,4-trivinylcyclohexane, or combinations thereof.

In accordance with the invention, the SiHy lens-forming composition can also comprises other polymerizable materials, such as, a UV-absorbing vinylic monomer, a UV/high-energy-violet-light (“HEVL”) absorbing vinylic monomer, a polymerizable tinting agent (polymerizable dye), or combinations thereof, as known to a person skilled in the art.

Any suitable UV-absorbing vinylic monomers and UV/HEVL-absorbing vinylic monomers can be used in a polymerizable composition for preparing a preformed SiHy contact lens of the invention. Examples of preferred UV-absorbing and UV/HEVL-absorbing vinylic monomers include without limitation: 2-(2-hydroxy-5-vinylphenyl)-2H-benzotriazole, 2-(2-hydroxy-5-acrylyloxyphenyl)-2H-benzotriazole, 2-(2-hydroxy-3-methacrylamido methyl-5-tert octylphenyl) benzotriazole, 2-(2′-hydroxy-5′-methacrylamidophenyl)-5-chlorobenzotriazole, 2-(2′-hydroxy-5′-methacrylamidophenyl)-5-methoxybenzotriazole, 2-(2′-hydroxy-5′-methacryloxypropyl-3′-t-butyl-phenyl)-5-chlorobenzotriazole, 2-(2′-hydroxy-5′-methacryloxypropylphenyl) benzotriazole, 2-hydroxy-5-methoxy-3-(5-(trifluoromethyl)-2H-benzo[d][1,2,3]triazol-2-yl)benzyl methacrylate (WL-1), 2-hydroxy-5-methoxy-3-(5-methoxy-2H-benzo[d][1,2,3]triazol-2-yl)benzyl methacrylate (WL-5), 3-(5-fluoro-2H-benzo[d][1,2,3]triazol-2-yl)-2-hydroxy-5-methoxybenzyl methacrylate (WL-2), 3-(2H-benzo[d][1,2,3]triazol-2-yl)-2-hydroxy-5-methoxybenzyl methacrylate (WL-3), 3-(5-chloro-2H-benzo[d][1,2,3]triazol-2-yl)-2-hydroxy-5-methoxybenzyl methacrylate (WL-4), 2-hydroxy-5-methoxy-3-(5-methyl-2H-benzo[d][1,2,3]triazol-2-yl)benzyl methacrylate (WL-6), 2-hydroxy-5-methyl-3-(5-(trifluoromethyl)-2H-benzo[d][1,2,3]triazol-2-yl)benzyl methacrylate (WL-7), 4-allyl-2-(5-chloro-2H-benzo[d][1,2,3]triazol-2-yl)-6-methoxyphenol (WL-8), 2-{2′-Hydroxy-3′-tert-5′[3″-(4″-vinylbenzyloxy)propoxy]phenyl}-5-methoxy-2H-benzotriazole, phenol, 2-(5-chloro-2H-benzotriazol-2-yl)-6-(1,1-dimethylethyl)-4-ethenyl- (UVAM), 2-[2′-hydroxy-5′-(2-methacryloxyethyl)phenyl)]-2H-benzotriazole (2-Propenoic acid, 2-methyl-, 2-[3-(2H-benzotriazol-2-yl)-4-hydroxyphenyl]ethyl ester, Norbloc), 2-{2′-Hydroxy-3′-tert-butyl-5′-[3′-methacryloyloxypropoxy]phenyl}-2H-benzotriazole, 2-{2′-Hydroxy-3′-tert-butyl-5′-[3′-methacryloyloxypropoxy]phenyl}-5-methoxy-2H-benzotriazole (UV13), 2-{2′-Hydroxy-3′-tert-butyl-5′-[3′-methacryloyloxypropoxy]phenyl}-5-chloro-2H-benzotriazole (UV28), 2-[2′-Hydroxy-3′-tert-butyl-5′-(3′-acryloyloxypropoxy)phenyl]-5-trifluoromethyl-2H-benzotriazole (UV23), 2-(2′-hydroxy-5-methacrylamidophenyl)-5-methoxybenzotriazole (UV6), 2-(3-allyl-2-hydroxy-5-methylphenyl)-2H-benzotriazole (UV9), 2-(2-Hydroxy-3-methallyl-5-methylphenyl)-2H-benzotriazole (UV12), 2-3′-t-butyl-2′-hydroxy-5′-(3″-dimethylvinylsilylpropoxy)-2′-hydroxy-phenyl)-5-methoxybenzotriazole (UV15), 2-(2′-hydroxy-5′-methacryloylpropyl-3′-tert-butyl-phenyl)-5-methoxy-2H-benzotriazole (UV16), 2-(2′-hydroxy-5′-acryloylpropyl-3′-tert-butyl-phenyl)-5-methoxy-2H-benzotriazole (UV16A), 2-Methylacrylic acid 3-[3-tert-butyl-5-(5-chlorobenzotriazol-2-yl)-4-hydroxyphenyl]-propyl ester (16-100, CAS #96478-15-8), 2-(3-(tert-butyl)-4-hydroxy-5-(5-methoxy-2H-benzo[d][1,2,3]triazol-2-yl)phenoxy)ethyl methacrylate (16-102); Phenol, 2-(5-chloro-2H-benzotriazol-2-yl)-6-methoxy-4-(2-propen-1-yl) (CAS #1260141-20-5); 2-[2-Hydroxy-5-[3-(methacryloyloxy)propyl]-3-tert-butylphenyl]-5-chloro-2H-benzotriazole; Phenol, 2-(5-ethenyl-2H-benzotriazol-2-yl)-4-methyl-, homopolymer (9C1) (CAS #83063-87-0). In accordance with the invention, the polymerizable composition comprises about 0.1% to about 3.0%, preferably about 0.2% to about 2.5%, more preferably about 0.3% to about 2.0%, by weight of one or more UV-absorbing vinylic monomers, related to the amount of all polymerizable components in the polymerizable composition.

A free radical initiator can be either a photoinitiator or a thermal initiator. A “photoinitiator” refers to a chemical that initiates free radical crosslinking/polymerizing reaction by the use of light. A “thermal initiator” refers to a chemical that initiates free radical crosslinking/polymerizing reaction by the use of heat energy.

Suitable thermal polymerization initiators are known to the skilled artisan and comprise, for example peroxides, hydroperoxides, azo-bis(alkyl- or cycloalkylnitriles), persulfates, percarbonates, or mixtures thereof. Examples of preferred thermal polymerization initiators include without limitation benzoyl peroxide, t-butyl peroxide, t-amyl peroxybenzoate, 2,2-bis(tert-butylperoxy)butane, 1,1-bis(tert-butylperoxy)cyclohexane, 2,5-Bis(tert-butylperoxy)-2,5-dimethylhexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxyphthalate, t-butyl hydroperoxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16S), di(2-ethylhexyl)peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis[2-(2-imidazolin-2-yl)propane]dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof. Preferably, the thermal initiator is 2,2′-azobis(isobutyronitrile) (AIBN or VAZO 64).

Suitable photoinitiators are benzoin methyl ether, diethoxyacetophenone, a benzoylphosphine oxide, 1-hydroxycyclohexyl phenyl ketone and Darocur and Irgacur types, preferably Darocur 1173® and Darocur 2959®, Germanium-based Norrish Type I photoinitiators (e.g., those described in U.S. Pat. No. 7,605,190). Examples of benzoylphosphine initiators include 2,4,6-trimethylbenzoyldiphenylophosphine oxide; bis-(2,6-dichlorobenzoyl)-4-N-propylphenylphosphine oxide; and bis-(2,6-dichlorobenzoyl)-4-N-butylphenylphosphine oxide. Reactive photoinitiators which can be incorporated, for example, into a macromer or can be used as a special monomer are also suitable. Examples of reactive photoinitiators are those disclosed in EP 632 329.

A polymerizable composition for filling recesses can be any polymerizable compositions so long as they comprise components required for imparting a desired functionality to resultant thin objects. For example, a polymerizable composition for making diffractive objects can be prepared by adding high refractive index material(s) into a known lens formulation; a polymerizable composition for making photochromatic objects can be prepared by adding one or more photochromatic material(s) into a known lens formulation; a polymerizable composition for making HEVL-block objects can be prepared by adding one or more HEVL-absorbing vinylic monomer/crosslinkers into a known lens formulation; a polymerizable composition for making selectively-color-filtering objects can be prepared by adding one or more materials capable of absorbing a desired color into a known lens formulation; a polymerizable composition for making drug delivering objects can be prepared by adding one or more drugs into a known lens formulation; a polymerizable composition for making comfort-imparting objects can be prepared by adding one or more leachable beneficial agents and/or one or more leachable wetting/lubricating agents into a known lens formulation; a polymerizable composition for making antimicrobial objects can be prepared by adding one or more antimicrobial agents into a known lens formulation; and a polymerizable composition for making anti-reflective objects can be prepared by adding one or more anti-reflective materials into a known lens formulation.

Any materials having high refractive index can be used in preparing a polymerizable composition. Examples of such high refractive index materials include without limitation nanoparticles (e.g., TiO₂, amorphous silicon, PbS, ZnS, etc.), aryl vinylic monomers, aryl vinylic crosslinkers, and combinations thereof.

Examples of preferred aryl vinylic monomers include, but are not limited to: 2-ethylphenoxy acrylate; 2-ethylphenoxy methacrylate; phenyl acrylate; phenyl methacrylate; benzyl acrylate; benzyl methacrylate; 2-phenylethyl acrylate; 2-phenylethyl methacrylate; 3-phenylpropyl acrylate; 3-phenylpropyl methacrylate; 4-phenylbutyl acrylate; 4-phenylbutyl methacrylate; 4-methylphenyl acrylate; 4-methylphenyl methacrylate; 4-methylbenzyl acrylate; 4-methylbenzyl methacrylate; 2-(2-methylphenyl)ethyl acrylate; 2-(2-methylphenyl)ethyl methacrylate; 2-(3-methylphenyl)ethyl acrylate; 2-(3-methylphenyl)ethyl methacrylate; 2-(4-methylphenyl)ethyl acrylate; 2-(4-methylphenyl)ethyl methacrylate; 2-(4-propylphenyl)ethyl acrylate; 2-(4-propylphenyl)ethyl methacrylate; 2-(4-(1-methylethyl)phenyl)ethyl acrylate; 2-(4-(1-methylethyl)phenyl)ethyl methacrylate; 2-(4-methoxyphenyl)ethyl acrylate; 2-(4-methoxy-phenyl)ethyl methacrylate; 2-(4-cyclohexylphenyl)ethyl acrylate; 2-(4-cyclohexylphenyl)ethyl methacrylate; 2-(2-chlorophenyl)ethyl acrylate; 2-(2-chlorophenyl)ethyl methacrylate; 2-(3-chlorophenyl)ethyl acrylate; 2-(3-chlorophenyl)ethyl methacrylate; 2-(4-chlorophenyl)ethyl acrylate; 2-(4-chlorophenyl)ethyl methacrylate; 2-(4-bromophenyl)ethyl acrylate; 2-(4-bromophenyl)ethyl methacrylate; 2-(3-phenylphenyl)ethyl acrylate; 2-(3-phenylphenyl)ethyl methacrylate; 2-(4-phenylphenyl)ethyl acrylate; 2-(4-phenylphenyl)ethyl methacrylate; 2-(4-benzylphenyl)ethyl acrylate; 2-(4-benzylphenyl)ethyl methacrylate; 2-(phenylthio)ethyl acrylate; 2-(phenylthio)ethyl methacrylate; 2-benzyloxyethyl acrylate; 3-benzyloxypropyl acrylate; 2-benzyloxyethyl methacrylate; 3-benzyloxypropyl methacrylate; 2-[2-(benzyloxy)ethoxy]ethyl acrylate; 2-[2-(benzyloxy)ethoxy]ethyl methacrylate; silicone-containing aryl vinylic monomers (e.g., p-vinylphenyltris(trimethylsiloxy)silane, m-vinylphenyltris(trimethylsiloxy)silane, o-vinylphenyltris(trimethylsiloxy)silane, p-styrylethyltris(trimethylsiloxy)silane, m-styrylethyl-tris(trimethylsiloxy)silane, o-styrylethyltris(trimethylsiloxy)silane); aryl-containing ene monomers; or combinations thereof. The above listed aryl acrylic monomers can be obtained from commercial sources or alternatively prepared according to methods known in the art.

Examples of aryl-containing ene monomers include without limitation vinyl naphthalenes, vinyl anthracenes, vinyl phenanthrenes, vinyl pyrenes, vinyl biphenyls, vinyl terphenyls, vinyl phenyl naphthalenes, vinyl phenyl anthracenes, vinyl phenyl phenanthrenes, vinyl phenyl pyrenes, vinyl phenyl terphenyls, phenoxy styrenes, phenyl carbonyl styrenes, phenyl carboxy styrenes, phenoxy carbonyl styrenes, allyl naphthalenes, allyl anthracenes, allyl phenanthrenes, allyl pyrenes, allyl biphenyls, allyl terphenyls, allyl phenyl naphthalenes, allyl phenyl anthracenes, allyl phenyl phenanthrenes, allyl phenyl pyrenes, allyl phenyl terphenyls, allyl phenoxy benzenes, allyl(phenylcarbonyl)benzenes, allyl phenoxy benzenes, allyl(phenyl carbonyl)benzenes, allyl(phenylcarboxy)benzenes, and allyl(phenoxy carbonyl)benzenes.

Examples of preferred aryl-containing ene monomers include without limitation styrene, 2,5-dimethylstyrene, 2-(trifluoromethyl)styrene, 2-chlorostyrene, 3,4-dimethoxystyrene, 3-chlorostyrene, 3-bromostyrene, 3-vinylanisole, 3-methylstyrene, 4-bromostyrene, 4-tert-butylstyrene, 2,3,4,5,6-pentanfluorostyrene, 2,4-dimethylstyrene, 1-methoxy-4-vinylbenzene, 1-chloro-4-vinylbenzene, 1-methyl-4-vinylbenzene, 1-(chloromethyl)-4-vinylbenzene, 1-(bromomethyl)-4-vinylbenzene, 3-nitrostyrene, 1,2-vinyl phenyl benzene, 1,3-vinyl phenyl benzene, 1,4-vinyl phenyl benzene, 4-vinyl-1,1′-(4′-phenyl)biphenylene, 1-vinyl-4-(phenyloxy)benzene, 1-vinyl-3-(phenyloxy)benzene, 1-vinyl-2-(phenyloxy)benzene, 1-vinyl-4-(phenyl carbonyl)benzene, 1-vinyl-3-(phenylcarboxy)benzene, 1-vinyl-2-(phenoxycarbonyl)benzene, allyl phenyl ether, 2-biphenylylallyl ether, allyl 4-phenoxyphenyl ether, allyl 2,4,6-tribromophenyl ether, allyl phenyl carbonate, 1-allyloxy-2-trifluoromethylbenzene, allylbenzene, 1-phenyl-2-prop-2-enylbenzene, 4-phenyl-1-butene, 4-phenyl-1-butene-4-ol, 1-(4-methylphenyl)-3-buten-1-ol, 1-(4-chlorophenyl)-3-buten-1-ol, 4-allyltoluene, 1-allyl-4-fluorobenzene, 1-allyl-2-methylbenzene, 1-allyl-3-methylbenzene, 1-allyl-3-methylbenzene, 2-allylanisole, 4-allylanisole, 1-allyl-4-(trifluromethyl)benzene, allylpentafluorobenzene, 1-allyl-2-methoxybenzene, 4-allyl-1,2-dimethoxybenzene, 2-allylphenol, 2-allyl-6-methylphenol, 4-allyl-2-methoxyphenol, 2-allyloxyanisole, 4-allyl-2-methoxyphenyl acetate, 2-allyl-6-methoxyphenol, 1-allyl-2-bromobezene, alpha-vinylbenzyl alcohol, 1-phenyl-3-butene-1-one, allylbenzyl ether, (3-allyloxy)propyl)benzene, allyl phenylethyl ether, 1-benzyloxy-4-pentene, (1-allyloxy)ethyl)benzene, 1-phenylallyl ethyl ether, (2-methyl-2-(2-propenyloxy)propyl)benzene, ((5-hexenyloxy)methyl)benzene, 1-allyloxy-4-propoxybenzene, 1-phenoxy-4-(3-prop-2-enoxypropoxy)benzene, 6-(4′-Hydroxyphenoxy)-1-Hexene, 4-but-3-enoxyphenol, 1-allyloxy-4-butoxybenzene, 1-allyloxy-4-ethoxybenzene, 1-allyl-4-benzyloxybenzene, 1-allyl-4-(phenoxy)benzene, 1-allyl-3-(phenoxy)benzene, 1-allyl-2-(phenoxy)benzene, 1-allyl-4-(phenyl carbonyl)benzene, 1-allyl-3-(phenyl carboxy)benzene, 1-allyl-2-(phenoxycarbonyl)benzene, 1,2-allyl phenyl benzene, 1,3-allyl phenyl benzene, 1,4-allyl phenyl benzene, 4-vinyl-1,1′-(4′-phenyl)biphenylene, 1-allyl-4-(phenyloxy)benzene, 1-allyl-3-(phenyloxy)benzene, 1-allyl-2-(phenyloxy)benzene, 1-allyl-4-(phenyl carbonyl)benzene, 1-allyl-3-(phenyl carboxy)benzene, and 1-allyl-2-(phenoxycarbonyl)benzene, 1-vinyl naphthylene, 2-vinyl naphthylene, 1-allyl naphthalene, 2-allyl naphthalene, allyl-2-naphthyl ether, 2-(2-methylprop-2-enyl)naphthalene, 2-prop-2-enylnaphthalene, 4-(2-naphthyl)-1-butene, 1-(3-butenyl)naphthalene, 1-allyl naphthalene, 2-allyl naphthalene, 1-allyl-4-napthyl naphthalene, 2-(allyloxy)-1-bromonaphthalene, 2-bromo-6-allyloxynaphthalene, 1,2-vinyl(1-naphthyl)benzene, 1,2-vinyl(2-naphthyl)benzene, 1,3-vinyl(1-naphthyl)benzene, 1,3-vinyl(2-naphthyl)benzene, 1,4-vinyl(1-naphthyl)benzene, 1,4-vinyl(2-naphthyl)benzene, 1-naphthyl-4-vinyl naphthalene, 1-allyl naphthalene, 2-allyl naphthalene, 1,2-allyl(1-naphthyl) benzene, 1,2-allyl(2-naphthyl)benzene, 1,3-allyl(1-naphthyl)benzene, 1,3-allyl(2-naphthyl)benzene, 1,4-allyl(1-naphthyl)benzene, 1,4-allyl(2-naphthyl)benzene, 1-allyl-4-napthyl naphthalene, 1-vinyl anthracene, 2-vinyl anthracene, 9-vinyl anthracene, 1-allyl anthracene, 2-allyl anthracene, 9-allyl anthracene, 9-pent-4-enylanthracene, 9-allyl-1,2,3,4-tetrachloroanthracene, 1-vinyl phenanthrene, 2-vinyl phenanthrene, 3-vinyl phenanthrene, 4-vinyl phenanthrene, 9-vinyl phenanthrene, 1-allyl phenanthrene, 2-allyl phenanthrene, 3-allyl phenanthrene, 4-allyl phenanthrene, 9-allyl phenanthrene, and combinations thereof.

Preferred aryl vinylic monomers are 2-phenylethyl acrylate; 3-phenylpropyl acrylate; 4-phenylbutyl acrylate; 5-phenylpentyl (meth)acrylate; 2-benzyloxyethyl (meth)acrylate; 3-benzyloxypropyl (meth)acrylate; 2-[2-(benzyloxy)ethoxy]ethyl (meth)acrylate; p-vinylphenyl-tris(trimethylsiloxy)silane; m-vinylphenyltris(trimethylsiloxy)silane; o-vinylphenyl-tris(trimethylsiloxy)silane; p-styrylethyltris(trimethylsiloxy)silane; m-styrylethyl-tris(trimethylsiloxy) silane; o-styrylethyltris(trimethylsiloxy)silane; or combinations thereof. Most preferred are p-vinylphenyltris(trimethylsiloxy)silane; m-vinylphenyltris(trimethylsiloxy)silane; o-vinylphenyl-tris(trimethylsiloxy)silane; p-styrylethyltris(trimethylsiloxy)silane; m-styrylethyl-tris(trimethylsiloxy) silane; o-styrylethyltris(trimethylsiloxy)silane; or combinations thereof.

Any aryl vinylic crosslinkers can be used. Examples of aryl vinylic crosslinkers include without limitation non-silicone aryl vinylic crosslinkers (e.g., divinylbenzene, 2-methyl-1,4-divinylbenzene, bis(4-vinylphenyl)methane, 1,2-bis(4-vinylphenyl)ethane, etc.), silicone-containing aryl vinylic crosslinkers.

Preferred silicone-containing aryl vinylic crosslinkers are aryl-containing polysiloxane vinylic crosslinkers each of which comprises: (1) a polydiorganosiloxane segment comprising dimethylsiloxane units and aryl-containing siloxane units each having at least one aryl-containing substituent having up to 45 carbon atoms; and (2) ethylenically-unsaturated groups (preferably (meth)acryloyl groups). In a preferred embodiment, the polydiorganosiloxane segment comprises at least 25% by mole of the aryl-containing siloxane units. The preferred aryl-containing polysiloxane vinylic crosslinkers can have a number average molecular weight of at least 1000 Daltons (preferably from 1500 Daltons to 100000 Daltons, more preferably from 2000 to 80000 Daltons, even more preferably from 2500 to 60000 Dalton).

Examples of such preferred aryl-containing polysiloxane vinylic crosslinkers include without limitation vinyl terminated polyphenylmethysiloxanes (e.g., PMV9925 from Gelest), vinylphenylmethyl terminated phenylmethyl-vinylphenylsiloxane copolymer (e.g., PVV-3522 from Gelest), vinyl terminated diphenylsiloxane-dimethylsiloxane copolymers (e.g., PDV-1625 from Gelest), (meth)acryloxyalkyl-terminated polyphenylmethysiloxanes, (meth)acryloxyalkyl-terminated phenylmethyl-vinylphenylsiloxane copolymers, (meth)acryloxyalkyl-terminated diphenylsiloxane-dimethylsiloxane copolymers, ethylenically-unsaturated group-terminated dimethylsiloxane-arylmethylsiloxane copolymers disclosed in U.S. Pat. Appl. Pub. No. 2022/00306810, or combinations thereof.

Examples of preferred photochromic compounds include polymerizable naphthopyrans, polymerizable benzopyrans, polymerizable indenonaphthopyrans, polymerizable phenanthropyrans, polymerizable spiro(benzindoline)-naphthopyrans, polymerizable spiro(indoline)benzopyrans, polymerizable spiro(indoline)-naphthopyrans, polymerizable spiro(indoline)quinopyrans, polymerizable spiro(indoline)-pyrans, polymerizable naphthoxazines, polymerizable spirobenzopyrans; polymerizable spirobenzopyrans, polymerizable spirobenzothiopyrans, polymerizable naphthacenediones, polymerizable spirooxazines, polymerizable spiro(indoline)naphthoxazines, polymerizable spiro(indoline)-pyridobenzoxazines, polymerizable spiro(benzindoline)pyridobenzoxazines, polymerizable spiro(benzindoline)naphthoxazines, polymerizable spiro(indoline)-benzoxazines, polymerizable diarylethenes, and combinations thereof, as disclosed in U.S. Pat. Nos. 4,929,693, 5,166,345 6017121, 7556750, 7584630, 7999989, 8158037, 8697770, 8741188, 9052438, 9097916, 9465234, 9904074, 10197707, 6019914, 6113814, 6149841, 6296785, and 6348604.

In one or more implementations, a polymerizable composition contains a drug to be administered via the contact lens. In this manner, the contact lenses can be used as a vehicle for sustained and controlled release of therapeutic agents. Moreover, by isolating the polymerizable composition to the recess(es), the drug can be targeted to specific areas of the wearer's eye. Generally, drug administration using this method offers several advantages over traditional eye drops or ointments, including improved drug bioavailability, prolonged drug retention on the ocular surface, and enhanced patient compliance. The drug can be released over time to provide a continuous supply of medication to the eye. The polymerizable composition can be designed to respond to environmental triggers (e.g., pH, temperature) to modulate drug release rates in response to specific conditions.

Anti-reflective (AR) objects can be served as anti-reflective coatings for reducing glare and reflections, which is particularly useful for wearers who spend significant time in front of screens or under artificial lighting. AR coatings provide enhanced visual clarity, reduced eye strain, improved night vision, and increased overall comfort.

UV/HEVL-blocking objects as UV/HEVL-blocking coatings can be used to protect the wearer's eyes from harmful radiation. UV/HEVL-blocking coatings reduce the risk of UV/HEVL-induced eye conditions, such as, cell damages, cataracts, and photokeratitis.

Anti-microbial objects as antimicrobial coatings can reduce the risk of bacterial and fungal infections on the lens surface. Anti-microbial coatings provide increased hygiene, reduced incidence of eye infections, and enhanced overall eye health.

Lubricating coatings can provide a smooth, lubricated surface to enhance comfort and reduce friction between the lens and the eye. Lubricating coatings can increase wearing comfort, reduce irritation, and extend wearing time. The polymerizable composition used to create the lubricating coating can include one or more lubricating agents, such as polyethylene glycol (PEG) or hyaluronic acid.

A lens formulation or a polymerizable composition can be a solventless liquid prepared by mixing all polymerizable components (or materials) and other necessary component (or materials) or a solution prepared by dissolving all of the desirable components (or materials) in any suitable solvent, such as, a mixture of water and one or more organic solvents miscible with water, an organic solvent, or a mixture of one or more organic solvents, as known to a person skilled in the art. The term “solvent” refers to a chemical that cannot participate in free-radical polymerization reaction (any of those solvents as described later in this application).

A solventless silicone hydrogel (SiHy) lens formulation typically comprises at least one blending vinylic monomer as a reactive solvent for dissolving all other polymerizable components of the solventless SiHy lens formulation. Examples of preferred blending vinylic monomers are described later in this application. Preferably, methyl methacrylate is used as a blending vinylic monomer in preparing a solventless SiHy lens formulation.

Examples of suitable solvents include acetone, methanol, cyclohexane, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimetyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-propanol, t-amyl alcohol, isopropanol, 1-methyl-2-pyrrolidone, N,N-dimethylpropionamide, dimethyl formamide, dimethyl acetamide, dimethyl propionamide, N-methyl pyrrolidinone, and mixtures thereof. More preferred organic solvents include without limitation methanol, ethanol, 1-propanol, isopropanol, sec-butanol, tert-butyl alcohol, tert-amyl alcohol, acetone, methyl ethyl ketone, methyl isopropyl ketone, methyl propyl ketone, ethyl acetate, heptane, methylhexane (various isomers), methylcyclohexane, dimethylcyclopentane (various isomers), 2,2,4-trimethylpentane, and mixtures thereof.

Mold halves for making contact lenses (or inserts) are well known to a person skilled in the art and, for example, are employed in cast molding. In general, a molding assembly comprises at least two mold halves, one male half and one female mold half. The male mold half has a first molding (or optical) surface which is in direct contact with a polymerizable composition for cast molding of a contact lens (or an insert) and defines the posterior (back) surface of a molded contact lens (or a molded insert); and the female mold half has a second molding (or optical) surface which is in direct contact with the polymerizable composition and defines the anterior (front) surface of the molded contact lens (or molded insert). The male and female mold halves are configured to receive each other such that a lens- or insert-forming cavity is formed between the first molding surface and the second molding surface.

Methods of manufacturing mold halves for cast-molding a contact lens or an insert are generally well known to those of ordinary skill in the art. The process of the present disclosure is not limited to any particular method of forming a mold half. In fact, any method of forming a mold half can be used in the present disclosure. The mold halves can be formed through various techniques, such as injection molding or lathing. Examples of suitable processes for forming the mold halves are disclosed in U.S. Pat. Nos. 4,444,711; 4,460,534; 5,843,346; and 5,894,002 (herein incorporated by reference in their entireties).

Virtually all materials known in the art for making mold halves can be used to make mold halves for making contact lenses or inserts. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used.

The lens formulation can be introduced into the mold half according to any techniques known to a person skilled in the art.

The curing of the lens formulation within the molding cavity of the molding assembly can be carried out thermally (i.e., by heating) or actinically (i.e., by actinic radiation, e.g., UV radiation and/or visible radiation) to activate the free-radical initiators.

The actinic polymerization of the lens formulation in a molding assembly can be carried out by irradiating the closed molding assembly with the lens formulation therein with an UV or visible light, according to any techniques known to a person skilled in the art.

The thermal polymerization of the lens formulation in a molding assembly can be carried out conveniently in an oven at a temperature of from 25 to 120° C. and preferably 40 to 100° C., as well known to a person skilled in the art. The reaction time may vary within wide limits, but is convenient, for example, from 1 to 24 hours or preferably from 2 to 12 hours. It is advantageous to previously degas the silicone-hydrogel-lens-forming composition and to carry out said copolymerization reaction under an inert atmosphere, e.g., under N2 or Ar atmosphere.

The step of separating the molding assembly can be carried out according to any techniques known to a person skilled in the art. It is understood that the preformed contact lens precursor is adhered onto one of the female and male mold halves having a molding surface free of any protrusions. Many techniques are known in the art. For example, the molding surface of the mold half designed to adhere the preformed contact lens precursor can be surface treated to render the preformed contact lens precursor preferentially adhered to the molding surface of this mold half. Alternatively, a compression force can be applied by using a mold-opening device to non-optical surface (opposite to the molding surface) of the mold half (not adhering the preformed contact lens precursor) of the molding assembly at a location about the center area of non-optical molding surface at an angle of less than about 30 degrees, preferably less than about 10 degrees, most preferably less than about 5 degrees (i.e., in a direction substantially normal to center area of non-optical molding surface) relative to the axis of the mold to deform the mold half, thereby breaking bonds between the molding surface of the mold half and the preformed contact lens precursor. Various ways of applying a force to non-optical surface of the mold half at a location about the center area of non-optical molding surface along the axis of the mold to deform the mold half which breaks the bonds between the optical molding surface of the mold half and the preformed contact lens precursor. It is understood that the mold-opening device can have any configurations known to a person skilled in the art for performing the function of separating two mold halves from each other.

A composite contact lens can be extracted with an extraction medium as well known to a person skilled in the art. The extraction liquid medium is any solvent capable of dissolving the diluent(s), unpolymerized polymerizable materials, and oligomers in the composite contact lens. Water, any organic solvents known to a person skilled in the art, or a mixture thereof can be used in the invention. Preferably, the organic solvents used extraction liquid medium are water, a buffered saline, a C1-C₃ alkyl alcohol, 1,2-propylene glycol, a polyethyleneglycol having a number average molecular weight of about 400 Daltons or less, a C1-C₆ alkylalcohol, or combinations thereof.

The extracted composite contact lens can then be hydrated according to any method known to a person skilled in the art.

The hydrated composite contact lens can be subjected to further processes, such as, for example, surface treatment, packaging in lens packages with a packaging solution which is well known to a person skilled in the art; sterilization such as autoclave at from 118° C. to 124° C. for at least about 30 minutes; and the like.

Lenses are packaged in individual packages, sealed, and sterilized (e.g., by autoclave at about 120° C. or higher for at least 30 minutes under pressure) prior to dispensing to users. A person skilled in the art will understand well how to seal and sterilize lens packages.

The present disclosure provides several advantages over conventional methods, such as those described above. A controlled motion and dosing apparatus disclosed herein allows for the precise application of ultrafine droplets, ensuring uniform layer thicknesses as thin as 0.5 microns—a level of precision unattainable with traditional methods. The controlled motion and dosing apparatus provides consistent application across the entire lens surface, reducing variability and improving the quality of the final product. The controlled motion and dosing apparatus versatility enables it to accommodate various designs and functional requirements, including drug delivery layers, optical enhancements, and comfort-improving coatings, with a customizable programming interface for easy adjustments. The automated nature of the controlled motion and dosing apparatus can reduce or eliminate need for manual intervention, increasing production efficiency and throughput while minimizing the potential for human error. By enabling the creation of ultrathin objects, the disclosed method reduces optical distortion and mechanical stress, enhancing the performance and comfort of the contact lenses. This is particularly beneficial for advanced lens designs such as diffractive multifocal and drug-eluting lenses.

The present disclosure may be understood more readily by reference to the following detailed description of example implementations taken in connection with the accompanying drawing figures, which form a part of this disclosure. It is to be understood that the present disclosure is not limited to the specific apparatuses, methods, conditions, or parameters described and/or shown herein, and that the terminology used herein is for the purpose of describing particular implementations by way of example only and is not intended to limit the claims.

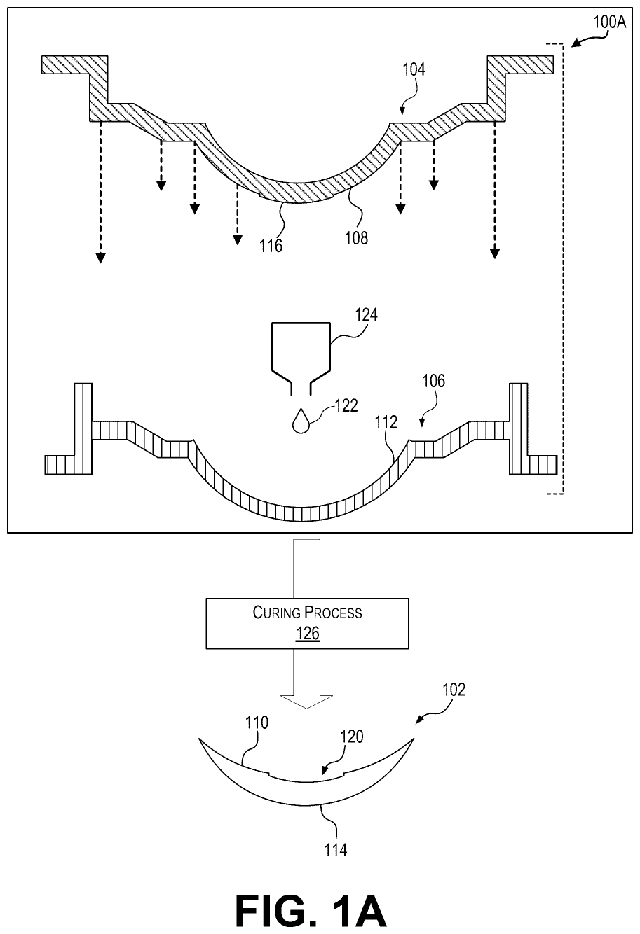

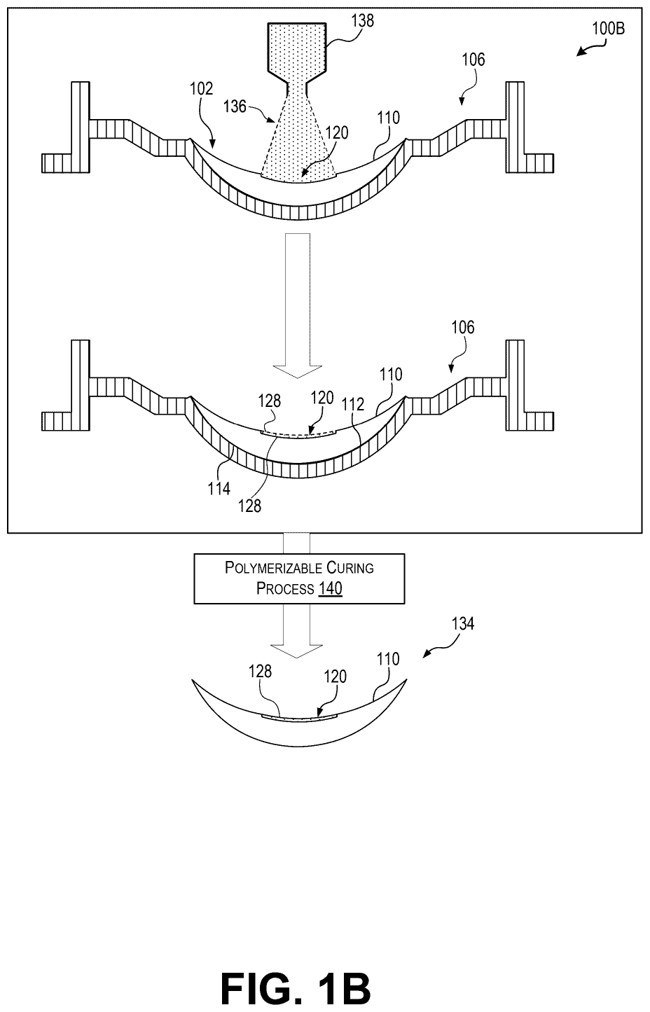

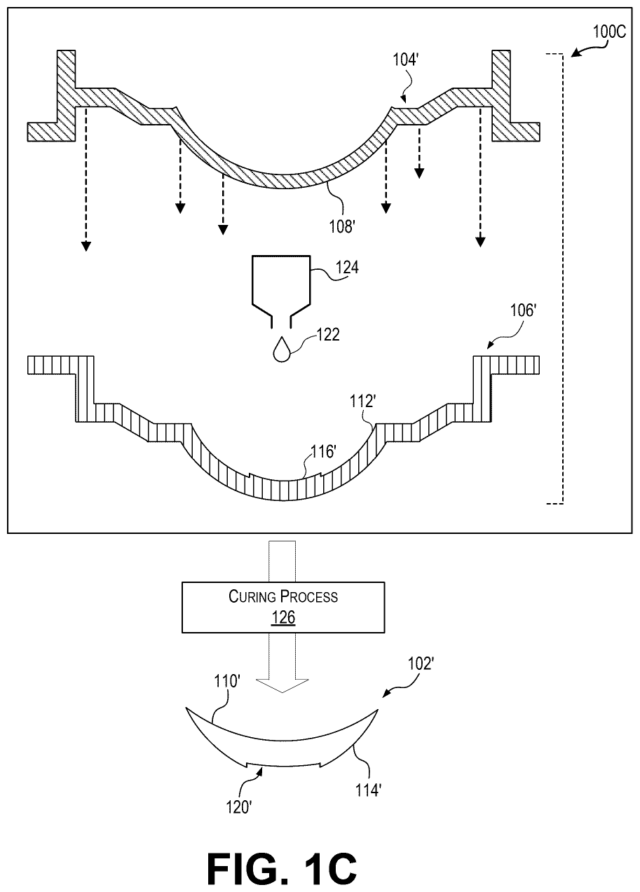

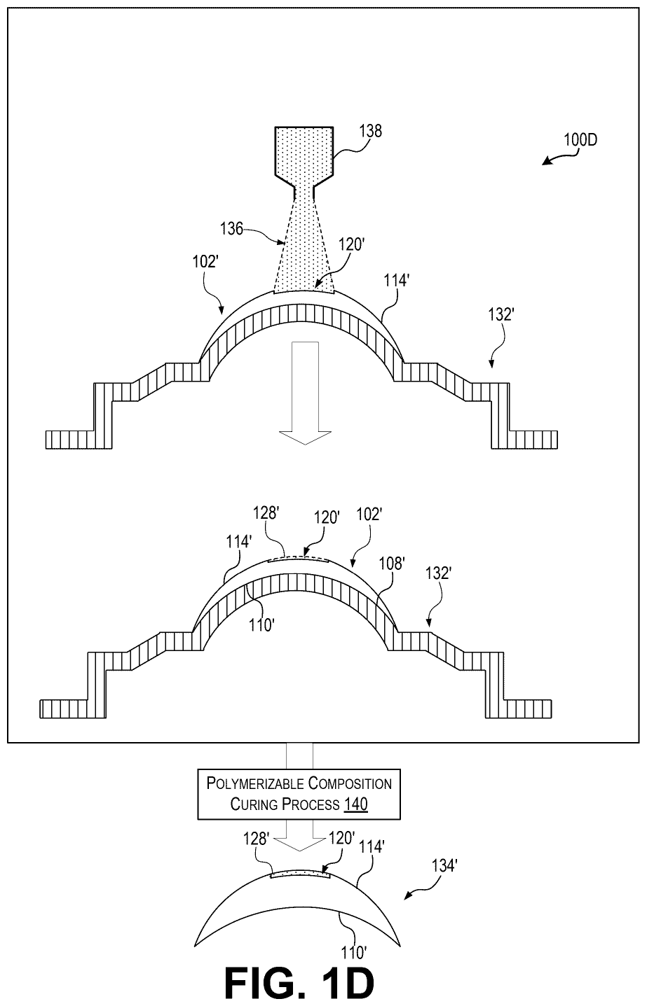

Turning now to FIG. 1A, a schematic diagram is shown depicting a process for making a preformed contact lens precursor 102 using a mold assembly 100A according to an example implementation. In particular, the mold assembly 100A includes a top mold portion 104 and a bottom mold portion 106. The top mold portion 104, also referred to as the male mold portion, has a convex molding surface 108 that determines a back curve (BC) surface 110 of the preformed contact lens precursor 102. The bottom mold portion 106, also referred to as the female mold portion, has a concave molding surface 112 that determines a front curve (FC) surface 114 of the preformed contact lens precursor 102.

In the illustrated implementation, the convex molding surface 108 includes a protrusion 116 that is located in a central area of the convex molding surface 108 and concentric with the central axis and that defines a recess 120 on the BC surface 110 of the preformed contact lens precursor 102 to be molded. In this manner, the BC surface 110 of the preformed contact lens precursor 102 also be referred to herein and in the claims as a “recess-containing surface.” The recess 120 is circular in shape and concentric with the central axis of the preformed contact lens precursor 102 and has side walls, a curved (concave) bottom surface, a depth of about 0.5 micron and about 30 microns, and a diameter of from about 2.5 mm to about 9.0 mm. One or more materials, such as a polymerizable composition, can be added to the recess 120 to enhance the performance, durability, comfort, and/or other characteristic(s) of a contact lens created according to the implementations described herein.

Prior to mating the top mold portion 104 with the bottom mold portion 106, a lens formulation 122 is dispensed into the bottom mold portion 106 using a lens formulation dispensing mechanism 124. The lens formulation 122 can be any lens formulations known to a person skilled in the art for making non-silicone hydrogel contact lenses or preferably silicone hydrogel contact lenses.

After the lens formulation 122 is dispensed into the bottom mold portion 106, the top mold portion 104 is placed over the bottom mold portion 106. Although this may be performed manually, automating this step can ensure precise placement and can mitigate the introduction air bubbles into the lens formulation 122. The two portions are then pressed together under controlled pressures to form a molding cavity for holding the lens formulation 122 and for defining the preformed contact lens precursor 102. The lens formulation 122, when cured, forms the preformed contact lens precursor 102 including the recess-containing BC surface 110, the FC surface 114, and the recess 120.

The top mold portion 104 and the bottom mold portion 106 can be designed to friction fit. Alternatively, the top mold portion 104 can be secured to the bottom mold portion 106 or vice versa using, for example, one or more clamps, one or more screws, one or more tabs, one or more adhesives, one or more other fasteners, or a combination thereof.

The mold assembly 100A can then be put through a curing process 126 to cure the lens formulation 122 and create the preformed contact lens precursor 102. The curing process 126 can be or can include an ultraviolet and/or visible light curing process or a thermal curing process.

FIG. 1B illustrates schematically a process of making a composite contact lens 134 having a thin object 128 partially embedded therewithin. In this illustrative example, after the curing step 126 shown in FIG. 1A, the molding assembly is opened in a way to ensure that the resultant preformed contact lens precursor 102 is adhered onto the concave molding surface 112 of the bottom mold portion 106. The recess 120 on the BC surface 110 of the preformed contact lens precursor 102 adhered on the bottom mold portion 106 can be filled with a polymerizable composition 136 by using a dispensing apparatus 138. The polymerizable composition 136 can be accurately and uniformly applied to the recess 120 to fully cover it with a layer of the polymerizable composition 136 in a way that a top surface of the layer merges with the recess-containing surface (e.g., the BC surface 110) and has a curvature substantially identical to the curvature of the recess-containing surface. The polymerizable composition in the recess 120 of the preformed contact lens precursor 102 adhered onto the bottom mold portion 106 can be cured actinically or thermally in the step 140 to form a composite contact lens 134. Subsequently, the composite contact lens can be removed from the bottom mold portion 106 according to any techniques known to a person skilled in the art. The obtained composite contact lens 134 comprises a think object 128 partially embedded in the composite contact lens 134 so that the exposed surface of the thin object 128 merges with the BC surface 110 of the composite contact lens 134 and has a curvature substantially identical to the curvature of the BC surface 110.

Alternatively, before the curing step 140, a capping mold half having a molding surface that conforms with the BC surface 110 of the composite contact lens 134 (e.g., the top mold portion 104′ of FIG. 1C) can be mated and pressed together with the bottom portion 106 having the preformed contact lens precursor 102 adhered thereon. Subsequently, the polymerizable composition in the recess can be cured. In such an implementation, the exposed surface of the thin object 128 can have an optical surface having a curvature identical to the curvature of the BC surface 110 of the composite contact lens 134.

The mold assembly 100A can be designed to accommodate various shapes, sizes, and locations for creating one or more recesses. In the illustrated example, one sole protrusion 116 has a circular, convex top surface on the convex molding surface 108 of the top mold portion 104. This implementation creates the circular recess 120 located centrally on the BC surface 110 of the preformed contact lens precursor 102. Alternatively, the bottom mold portion 106 can be configured with the protrusion 116, such that the circular recess 120 is created on the FC surface 114 (i.e., the FC surface 114 is the recess-containing surface). An example of this alternative implementation is illustrated and described herein with reference to FIGS. 1C-1D.

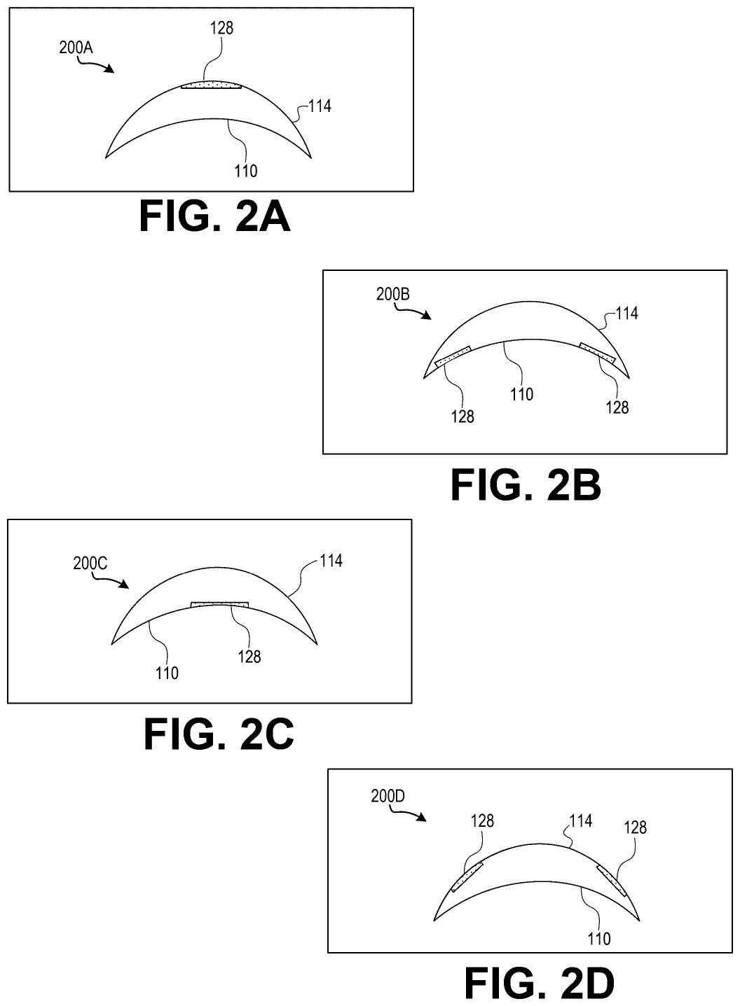

In other implementations, the protrusion 116 can be aligned around a different location on the mold portion to create the recess 120 at a different location on the preformed contact lens precursor 102. Some examples of where the recess 120 may be created are illustrated and described herein with reference to FIGS. 2A-2D. Moreover, the protrusion 116 are shown on the top mold portion 104. This implementation creates the recess 120 on the BC surface 110 (i.e., the BC surface 110 is the recess-containing surface). Alternatively, the bottom mold portion 106 can be configured with the protrusion 116, such that the recess 120 is created on the FC surface 114 (i.e., the FC surface 114 is the recess-containing surface). An example of this alternative implementation is illustrated and described herein with reference to FIGS. 1C-1D.

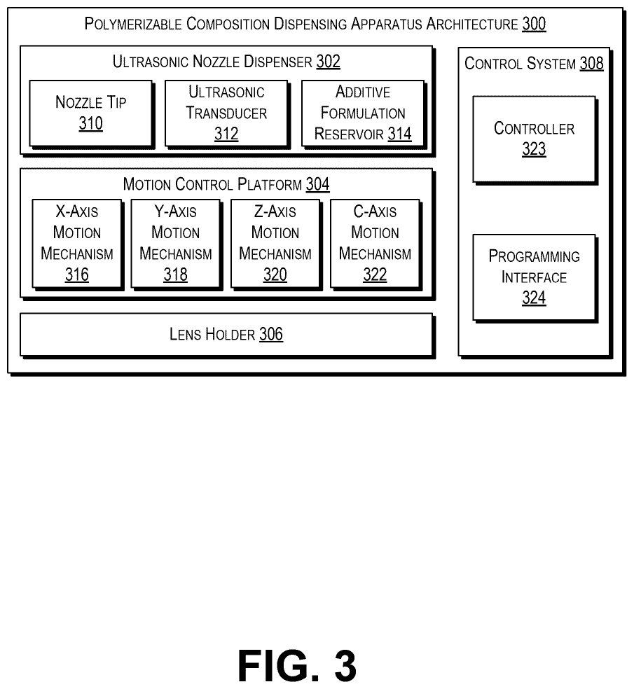

The polymerizable composition dispensing apparatus 138 can provide ultrasonic dosing with XYZ or XYZC motion control that allows for precise application of the polymerizable composition 136 with ultrathin objects, e.g., ranging from 0.5 to 30 microns. This precision ensures uniform coverage, minimizes optical distortion, and enhances the functional benefits of each coating. The ability to apply multiple types of coatings in a controlled manner opens up new possibilities for advanced contact lens designs, combining various enhancements in a single lens to meet the specific needs of different wearers. Additional details of the polymerizable composition dispensing apparatus 138 will now be described below with reference to FIG. 3.

Turning now to FIG. 3, a block diagram is shown depicting an example polymerizable composition dispensing apparatus architecture 300, according to an example implementation. In one or more implementations, the polymerizable composition dispensing apparatus 138 utilizes an architecture similar to or the same as the polymerizable composition dispensing apparatus architecture 300. The polymerizable composition dispensing apparatus architecture 300 includes an ultrasonic nozzle dispenser 302, a motion control platform 304, a lens holder 306, and a control system 308.

The ultrasonic nozzle dispenser 302 is used for the precise application of ultrafine formulation droplets of the polymerizable composition 136 into the recess 120. The ultrasonic nozzle dispenser 302 can atomize the polymerizable composition 136 into extremely fine droplets, ensuring uniform and controlled deposition of the polymerizable composition in the recess 120.

The ultrasonic nozzle dispenser 302 includes a nozzle tip 310. The nozzle tip 310 can be made from durable materials, such as stainless steel or ceramic, to withstand high-frequency vibrations and can feature a finely-tuned opening that allows the polymerizable composition 136 to be emitted as a mist of tiny droplets. The design and shape of the nozzle tip 310 can be chosen based on the desired droplet size and spray pattern to achieve a desired coating uniformity and thickness.

The ultrasonic nozzle dispenser 302 also includes an ultrasonic transducer 312. The ultrasonic transducer 312 generates high-frequency ultrasonic vibrations. The ultrasonic transducer 312 converts electrical energy into mechanical vibrations and transmits these vibrations to the nozzle tip 310. When activated, the ultrasonic transducer 312 produces ultrasonic waves that cause the polymerizable composition 136 at the nozzle tip 310 to vibrate intensely. This vibration breaks the polymerizable composition 136 into ultrafine droplets, creating a consistent and controlled spray. The precise atomization achieved through this process ensures that the polymerizable composition 136 is uniformly applied within the recess 120.

The ultrasonic nozzle dispenser 302 also includes an additive formulation reservoir 314. The additive formulation reservoir 314 can hold and supply the polymerizable composition to be atomized. The additive formulation reservoir 314 can include a mechanism for maintaining a constant supply of polymerizable composition 136 to the nozzle tip 310. This constant supply maintains the uniformity and consistency of the applied polymerizable composition to achieve the desired thickness and functionality of the polymerizable composition layer(s) 128.

The motion control platform 304 provides precise movement and positioning of the ultrasonic nozzle dispenser 302 above the recess 120, ensuring accurate and uniform application of the polymerizable composition 136. The motion control platform 304 can be configured to move the ultrasonic nozzle dispenser 302, the contact lens itself, or both. The motion control platform 304 can provide four distinct axes of motion—X, Y, Z, and optionally C—via respective motion mechanisms 316, 318, 320, 322.

The X-axis motion mechanism 316 allows the ultrasonic nozzle dispenser 302 to move laterally across the recess 120. This lateral movement, controlled by precision motors and guided rails, ensures that the ultrasonic nozzle dispenser 302 can traverse the width of the recess 120, the entire contact lens, or any other surface being coated. The high degree of control over the X-axis provided by the X-axis motion mechanism 316 enables the ultrasonic nozzle dispenser 302 above to follow specific paths, ensuring that every part of the recess 120 receives an even distribution of the polymerizable composition 136.

The Y-axis motion mechanism 318 enables the ultrasonic nozzle dispenser 302 to move forward and backward. This movement, also controlled by precision motors and guided rails, allows the ultrasonic nozzle dispenser 302 to cover the entire horizontal plane of the recess 120. By combining the X and Y movements, the polymerizable composition dispensing apparatus 138 can position the ultrasonic nozzle dispenser 302 over any point on the recess 120 with high accuracy, ensuring comprehensive coverage and uniform application of the polymerizable composition 136.

The Z-axis motion mechanism 320 is responsible for vertical movement, allowing the ultrasonic nozzle dispenser 302 to move up and down. The Z-axis is used for adjusting the distance between the nozzle tip 310 and the target surface, which directly impacts the droplet size and the thickness of the applied layer. The ability to fine-tune the Z-axis position ensures that the polymerizable composition 136 is deposited with the desired thickness and precision.

The C-axis motion mechanism 322 introduces rotational movement around the Z-axis, allowing the ultrasonic nozzle dispenser 302 to rotate relative to the recess 120. This rotational capability ensures that the ultrasonic nozzle dispenser 302 can be positioned at precise angles, which is especially useful when coating irregularly shaped surfaces or achieving specific deposition patterns. The C-axis motion, combined with the X, Y, and Z movements, provides greater flexibility and control over the material application, allowing for uniform coating even in complex geometries or angled surfaces.

The lens holder 306 securely holds the capping mold 100B, the preformed contact lens precursor 102, or other target surfaces in place. The lens holder 306 can rotate to ensure even application of the polymerizable composition 136 on curved surfaces.

The control system 308 coordinates the movements of all axes via the motion control platform 304 via a controller 323 and can receive input via a programming interface 324 to program the controller 323 to follow predetermined patterns or sequences. The controller 323 processes these inputs and translates the input into precise motor commands to be implemented by the motion mechanisms 316, 318, 320, ensuring that the ultrasonic nozzle dispenser 302 moves smoothly and accurately across the target surface.

Returning to FIG. 1B, the polymerizable composition dispensing apparatus 138 is activated to cause the ultrasonic transducer 312 to generate high-frequency vibrations to cause atomization of the polymerizable composition 136 into ultrafine droplets to be dispensed through the nozzle tip 310. The motion control platform 304 moves the ultrasonic nozzle dispenser 302 in four dimensions—X (left and right), Y (forward and backward), Z (up and down), and C (rotational movement around the Z-axis)—via respective motion mechanisms 316, 318, 320, 322 allowing for meticulous control over the position of the ultrasonic nozzle dispenser 302 relative to the recess 120.

This movement ensures that the polymerizable composition 136 is deposited uniformly across the entire recess 120. The ability to control the Z-axis adjusts the distance between the nozzle tip 310 and the lens, which directly influences the droplet size and the thickness of the applied layer. Additionally, the C-axis enables the ultrasonic nozzle dispenser 302 to rotate, allowing for precise angular positioning to further enhance the uniformity and coverage of the material on complex or irregularly shaped surfaces.

The combination of ultrasonic dosing and XYZ or XYZC motion control provided by the polymerizable composition dispensing apparatus 138 allows for the creation of a material layer with a precise thickness ranging from 0.5 to 30 microns.

Once the material layer is uniformly deposited, the lens is ready for a polymerizable composition curing process 140, which solidifies the polymerizable composition layer(s) 128 and ensures proper adhesion to the preformed contact lens precursor 102 to create the composite contact lens 134. The polymerizable composition curing process 140 can be or can include an ultraviolet light curing process, a thermal curing process, another curing method, or some combination thereof.

Curing the polymerizable composition layer(s) 128 in the recess 120 to form the composite contact lens 134 comprising thin objects that are made of a second crosslinked polymeric material (i.e., different from a first crosslinked polymeric materials used to form the preformed contact lens precursor 102) and has a thickness of between about 0.5 micron and about 30 microns and a width or length of greater than about 2.0 millimeters, wherein each thin object is partially embedded in the contact lens 134 and includes a buried surface and an exposed surface opposite the buried surface, wherein the buried surface is in contact directly with the first crosslinked polymeric material whereas the exposed surface merges with an anterior surface or a posterior surface of the contact lens 134 and has a curvature substantially identical to the curvature of the anterior surface or the posterior surface of the contact lens 134.

Turning now to FIG. 1C, a schematic diagram is shown depicting another mold assembly 1000 used to form a preformed contact lens precursor 102′ according to another example implementation. In particular, the mold assembly 1000 includes a top mold portion 104′ and a bottom mold portion 106′. The top mold portion 104′, also referred to as the male mold portion, has a convex molding surface 108′ that determines a BC surface 110′ of the preformed contact lens precursor 102′ after the curing process 126. The bottom mold portion 106′, also referred to as the female mold portion, has a concave molding surface 112′ that determines an FC surface 114′ of the preformed contact lens precursor 102 after the curing process 126.

In the illustrated implementation, the concave surface 112′ of the bottom mold portion 106′ includes a protrusion 116′. In this manner, a recess 120′ is formed on the FC surface 114′ of the preformed contact lens precursor 102′ after the curing process 126. The FC surface 114′ is a recess-containing surface. The recess 120′ is circular in shape and concentric with the central axis of the preformed contact lens precursor 102′ and has side walls, a curved (convex) bottom surface, a depth of about 0.5 micron and about 30 microns, and a diameter of from about 2.5 mm to about 9.0 mm.

Prior to mating the convex molding surface 108′ of the top mold portion 104′ with the concave molding surface 112′ of the bottom mold portion 106′, the lens formulation 122, such as described above, is dispensed into the bottom mold portion 106′ using the lens formulation dispensing mechanism 124.

After the lens formulation 122 is dispensed into the bottom mold portion 106′, the top mold portion 104′ is placed over the bottom mold portion 106. Although this may be performed manually, automating this step can ensure precise placement and can mitigate the introduction air bubbles into the lens formulation 122. The two portions are then pressed together under controlled pressures. This creates a thin, uniform layer of the lens formulation 122 between the top mold portion 104′ and the bottom mold portion 106′. The lens formulation 122, when cured, forms the preformed contact lens precursor 102′ including the BC surface 110′, the recess-containing FC surface 114′, and the recess 120′.

The top mold portion 104′ and the bottom mold portion 106′ can be designed to friction fit. Alternatively, the top mold portion 104′ can be secured to the bottom mold portion 106′ or vice versa using, for example, one or more clamps, one or more screws, one or more tabs, one or more adhesives, one or more other fasteners, or a combination thereof.

The mold assembly 1000 can then be put through the curing process 126 to cure the lens formulation 122 and create the preformed contact lens precursor 102′. The curing process 126 can be or can include an ultraviolet and/or visible light curing process or a thermal curing process.

The mold assembly 1000 can be designed to accommodate various shapes, sizes, and locations for creating one or more recess 120′. In the illustrated example, one sole protrusion 116′ has a circular, concave top surface on the concave molding surface 112′ of the bottom mold portion 106′.

Turning now to FIG. 1D, a schematic diagram is shown depicting a process of making a composite contact lens 134′. In this illustrative example, after the curing step 126 shown in FIG. 1C, the molding assembly is opened in a way to ensure that the resultant preformed contact lens precursor 102′ is adhered onto the convex molding surface of the top mold portion 132′ (corresponding to the top mold portion 104′ in FIG. 1C). The recess 120′ on the FC surface 114′ of the preformed contact lens precursor 102′ adhered on the top mold portion can be filled with a polymerizable composition 136 by using a dispensing apparatus 138. The polymerizable composition 136 can be accurately and uniformly applied to the recess 120′ to fully cover it with a layer of the polymerizable composition 136 in a way that a top surface of the layer merges with the recess-containing surface (e.g., the FC surface 114′) and has a curvature substantially identical to the curvature of the recess-containing surface. The polymerizable composition in the recess 120′ of the preformed contact lens precursor 102′ adhered onto the top mold portion can be cured actinically or thermally in the step 140 to form a composite contact lens 134′. Subsequently, the composite contact lens can be removed from the top mold portion according to any techniques known to a person skilled in the art. The obtained composite contact lens 134′ comprises a think object 128′ partially embedded in the composite contact lens 134′ so that the exposed surface of the thin object 128′ merges with the FC surface 114′ of the composite contact lens 134′ and has a curvature substantially identical to the curvature of the FC surface 114′.

The polymerizable composition dispensing apparatus 138 is activated to cause the ultrasonic transducer 312 (shown in FIG. 3) to generate high-frequency vibrations to cause atomization of the polymerizable composition 136 into ultrafine droplets to be dispensed through the nozzle tip 310. The motion control platform 304 moves the ultrasonic nozzle dispenser 302 in three dimensions—X (left and right), Y (forward and backward), and Z (up and down)—via respective motion mechanisms 316, 318, 320 allowing for meticulous control over the position of the ultrasonic nozzle dispenser 302 relative to the recess 120′. This movement ensures that the polymerizable composition 136 is deposited uniformly across the entire recess 120′. The ability to control the Z-axis adjusts the distance between the nozzle tip 310 and the lens, which directly influences the droplet size and the thickness of the applied layer. The combination of ultrasonic dosing and XYZ or XYZC motion control provided by the polymerizable composition dispensing apparatus 138 allows for the creation of a material layer with a precise thickness ranging from 0.5 to 30 microns.

Turning now to FIGS. 2A-2D, diagrams are shown depicting composite contact lenses 200A-200D including different configurations of thin objects 128 according to example implementations. It should be understood that these configurations are merely exemplary and should not be considered limiting in any way. FIG. 2A depicts a composite contact lens 200A having a single thin circular object 128 centered on the FC surface 114. FIG. 2B depicts a composite contact lens 200B having a thin annular object 128 positioned near the outer edges of the BC surface 110. FIG. 2C depicts a composite contact lens 2000 having a single thin circular object 128 centered on the BC surface 110. FIG. 2D depicts a composite contact lens 200D having a thin annular object 128 positioned near the outer edges of the FC surface 114.

It should be understood that many variations are possible based on the disclosure herein. Although features and elements are described above in particular combinations, each feature or element is usable alone without the other features and elements or in various combinations with or without other features and elements.

Although various embodiments of the invention have been described using specific terms, devices, and methods, such description is for illustrative purposes only. The words used are words of description rather than of limitation. As would be obvious to one skilled in the art, many variations and modifications of the invention may be made by those skilled in the art without departing from the spirit and scope of the novel concepts of the disclosure. In addition, it should be understood that aspects of the various embodiments of the invention may be interchanged either in whole or in part or can be combined in any manner and/or used together, as illustrated below:

1. A method for producing contact lenses, comprising the steps of:
(1) obtaining a preformed contact lens precursor that is made of a first crosslinked polymeric material and comprises a front surface and a back surface opposite the front surface, wherein one of the front surface and the back surface is a recess-containing surface comprising one or more recesses each of which has side walls, a bottom surface, a depth of between about 0.5 micron and about 30 microns, and a width or length of greater than about 2.0 mm;
(2) accurately and uniformly applying a polymerizable composition to the one or more recesses to fully cover each recess with a layer of the polymerizable composition in a way that a top surface of the layer merges with the recess-containing surface and has a curvature substantially identical to the curvature of the recess-containing surface; and
(3) curing actinically or thermally the polymerizable composition in the recesses to form a contact lens comprising thin objects that are made of a second crosslinked polymeric material and has a thickness of between about 0.5 micron and about 30 microns and a width or length of greater than about 2.0 millimeters, wherein each thin object is partially embedded in the contact lens and comprises a buried surface and an exposed surface opposite the buried surface, wherein the buried surface is in contact directly with the first crosslinked polymeric material whereas the exposed surface merges with an anterior surface or a posterior surface of the contact lens and has a curvature substantially identical to the curvature of the anterior surface or the posterior surface of the contact lens.

2. The method of embodiment 1, wherein the method further comprises, between steps (2) and (3), a step of placing and pressing a capping mold half onto the recess-containing surface comprising the one or more recesses filled with the polymerizable composition therein.

3. The method of embodiment 1 or 2, wherein the preformed contact lens precursor is obtained by:
dispensing a lens formulation into a mold assembly, the mold assembly comprising a bottom mold portion with a first molding surface and a top mold portion with a second molding surface, wherein a molding cavity for holding the lens formulation is formed between the first and second molding surfaces when the bottom mold portion and the top mold portion are mated and pressed tightly together, wherein one of the first and second molding surfaces comprises one or more raised portions which conform to the recesses in the preformed contact lens precursor; and
curing actinically or thermally the lens formulation to form the preformed contact lens precursor.

4. The method of any one of embodiments 1 to 3, wherein the first molding surface comprises the one or more raised portions which conform to the recesses in the preformed contact lens precursor.

5. The method of any one of embodiments 1 to 3, wherein the second molding surface comprises the one or more raised portions which conform to the recesses in the preformed contact lens precursor.

6. The method of any one of embodiments 1 to 5, wherein accurately and uniformly applying the polymerizable composition to the one or more recessed areas comprises moving a motion control platform along at least one axis to precisely control application of the polymerizable composition via an ultrasonic nozzle dispenser.

7. The method of any one of embodiments 1 to 6, wherein the preformed contact lens precursor comprises a circular recess which is concentric with central axis of the preformed contact lens precursor and has a diameter of from about 2.0 mm to about 10.0 mm.

8. The method of any one of embodiments 1 to 6, wherein the preformed contact lens precursor comprises an annular recess which is concentric with central axis of the preformed contact lens precursor and has an inner diameter of from about 2.0 mm to about 6.0 mm.

9. The method of any one of embodiments 1 to 6, wherein the preformed contact lens precursor comprises a series of recesses arranged in a ring outside of the optical zone of the recess-containing surface, wherein each recess has a shape of a circle, an oval, a polygon.

10. The method of embodiment 7 or 8, wherein the bottom surface of the recess comprises a diffractive structure for providing multifocal power, wherein the polymerizable composition comprises at least one aryl vinylic monomer and/or at least one aryl vinylic crosslinker together in an amount sufficient to impart the second crosslinked polymeric material with a refractive index which is at least 0.03 higher than the refractive index of the first crosslinked polymeric material.

11. The method of embodiment 10, wherein polymerizable composition comprises at least one member selected from the group consisting of: 2-phenylethyl acrylate; 3-phenylpropyl acrylate; 4-phenylbutyl (meth)acrylate; 5-phenylpentyl (meth)acrylate; 2-benzyloxyethyl (meth)acrylate; 3-benzyloxypropyl (meth)acrylate; 2-[2-(benzyloxy)ethoxy]ethyl (meth)acrylate; p-vinylphenyl-tris(trimethylsiloxy) silane; m-vinylphenyltris(trimethylsiloxy) silane; o-vinylphenyl-tris(trimethylsiloxy) silane; p-styrylethyltris(trimethylsiloxy) silane; m-styrylethyl-tris(trimethylsiloxy) silane; o-styrylethyltris(trimethylsiloxy) silane; divinylbenzene, 2-methyl-1,4-divinylbenzene; bis(4-vinylphenyl)methane; 1,2-bis(4-vinylphenyl)ethane; a silicone-containing aryl vinylic crosslinker, and combinations thereof.

12. The method of embodiment 7, wherein the polymerizable composition comprises at least one HEVL-absorbing vinylic monomer, at least one photochromic compound, at least one anti-reflective material, at least one dyes capable of selectively filtering a color light, or combinations thereof.

13. The method of embodiment 8 or 9, wherein the polymerizable composition comprises at least one drug and/or at least one beneficial agent.

14. The method of any one of embodiments 1 to 12, wherein the front surface of the preformed contact lens precursor is the recess-containing surface.

15. The method of any one of embodiments 1 to 13, wherein the back surface of the preformed contact lens precursor is the recess-containing surface.

16. The method of any one of embodiments 1 to 15, wherein the lens formulation is suitable for forming a non-silicone hydrogel material and is either (1) a monomeric reaction composition comprising (a) at least one hydrophilic vinylic monomer and (b) at least one component selected from the group consisting of a vinylic crosslinker, a hydrophobic vinylic monomer, a free-radical initiator, a UV-absorbing vinylic monomer, a HEVL-absorbing vinylic monomer, a visibility tinting agent, and combinations thereof, or (2) an aqueous solution comprising one or more water-soluble prepolymers and at least one component selected from the group consisting of hydrophilic vinylic monomer, a crosslinking agent, a hydrophobic vinylic monomer, a lubricating agent, a free-radical initiator, a UV-absorbing vinylic monomer, a HEVL absorbing vinylic monomer, a visibility tinting agent, and combinations thereof.

17. The method of any one of embodiments 1 to 15, wherein the lens formulation is suitable for forming a silicone hydrogel material and comprises (a) at least one silicone-containing vinylic monomer and/or at least one polysiloxane vinylic crosslinker, (b) at least one hydrophilic vinylic monomer, (c) at least one free-radical initiator, (d) at least one component selected from the group consisting of at least one non-silicone vinylic crosslinker, at least one UV-absorbing vinylic monomer, at least one HEVL-absorbing vinylic monomer, a visibility tinting agent, and combinations thereof.

18. A contact lens that comprises a lens body comprising: an anterior surface, a posterior surface opposite the anterior surface, a bulk hydrogel material, and one or more thin plastic objects partially embedded in the bulk hydrogel material, wherein the thin plastic objects are made of a crosslinked polymeric material different from the bulk hydrogel material and has a thickness of between about 0.5 micron and about 30 microns and a width or length of greater than about 2.0 mm, wherein each thin plastic object comprises a buried surface and an exposed surface opposite the buried surface, wherein the buried surface is in contact directly with the bulk hydrogel material whereas the exposed surface merges with the anterior surface or the posterior surface of the contact lens and has a curvature substantially identical to the curvature of the anterior surface or the posterior surface of the contact lens.

19. The contact lens of embodiment 18, wherein the lens body comprises one circular thin plastic object which is concentric with central axis of the contact lens and has a diameter of from about 2.0 mm to about 10.0 mm.

20. The contact lens of embodiment 18, wherein the lens body comprises one annular thin plastic object which is concentric with central axis of the contact lens and has an inner diameter of from about 2.0 mm to about 6.0 mm.

21. The contact lens of embodiment 18, wherein the lens body comprises a series of thin plastic objects arranged in a ring outside of the optical zone of the anterior or posterior surface, wherein each think plastic object has a shape of a circle, an oval, a polygon.

22. The contact lens of embodiment 19 or 20, wherein the buried surface of the thin plastic object comprises a diffractive structure for providing multifocal power, wherein the crosslinked polymeric material has a refractive index which is at least 0.03 higher than the refractive index of the first crosslinked polymeric material.

23. The contact lens of embodiment 22, wherein the crosslinked polymeric material comprises aryl-containing repeating units of at least one aryl vinylic monomer and/or at least one aryl vinylic crosslinker.

24. The contact lens of embodiment 23, wherein said at least one aryl vinylic monomer is selected from the group consisting of 2-phenylethyl acrylate, 3-phenylpropyl acrylate, 4-phenylbutyl (meth)acrylate, 5-phenylpentyl (meth)acrylate, 2-benzyloxyethyl (meth)acrylate; 3-benzyloxypropyl (meth)acrylate, 2-[2-(benzyloxy)ethoxy]ethyl (meth)acrylate, p-vinylphenyl-tris(trimethylsiloxy) silane, m-vinylphenyltris(trimethylsiloxy) silane; o-vinylphenyl-tris(trimethylsiloxy) silane, p-styrylethyltris(trimethylsiloxy) silane, m-styrylethyl-tris(trimethylsiloxy) silane, o-styrylethyltris(trimethylsiloxy) silane, and combinations thereof, wherein said at least one aryl vinylic crosslinker is selected from the group consisting of divinylbenzene, 2-methyl-1,4-divinylbenzene; bis(4-vinylphenyl)methane; 1,2-bis(4-vinylphenyl)ethane; a silicone-containing aryl vinylic crosslinker, and combinations thereof.

25. The contact lens of embodiment 19, wherein the crosslinked polymeric material comprises: repeating units of at least one HEVL-absorbing vinylic monomer, at least one photochromic compound, at least one anti-reflective material, at least one dyes capable of selectively filtering a color light, or combinations thereof.

26. The contact lens of embodiment 20 or 21, wherein the crosslinked polymeric material comprises at least one drug and/or at least one beneficial agent.

27. The contact lens of any one of embodiments 18 to 25, wherein the exposed surface of each of the one or more thin plastic objects merges with the anterior surface of the contact lens and has a curvature substantially identical to the curvature of the anterior surface of the contact lens.

28. The contact lens of any one of embodiments 18 to 26, wherein the exposed surface of each of the one or more thin plastic objects merges with the posterior surface of the contact lens and has a curvature substantially identical to the curvature of the posterior surface of the contact lens.

29. The contact lens of any one of embodiments 18 to 28, wherein the bulk hydrogel material is a non-silicone hydrogel material which comprises (a) repeating units of at least hydrophilic vinylic monomer selected from the group consisting of a hydroxyl-containing acrylic monomer, N-vinyl amide monomer, a methylene-containing pyrrolidone monomer, and combinations thereof and (b) repeating units of at least polymerizable component selected from the group consisting of a vinylic crosslinker, a hydrophobic vinylic monomer, a UV-absorbing vinylic monomer, a HEVL-absorbing vinylic monomer, a polymerizable dye, and combinations thereof.

30. The contact lens of any one of embodiments 18 to 28, wherein the bulk hydrogel material is a silicone hydrogel material which comprises (a) repeating units of at least one silicone-containing vinylic monomer and/or at least one polysiloxane vinylic crosslinker, (b) repeating units of at least hydrophilic vinylic monomer, (c) repeating units of at least one polymerizable component selected from the group consisting of at least one non-silicone vinylic crosslinker, at least one UV-absorbing vinylic monomer, at least one HEVL-absorbing vinylic monomer, a polymerizable dye, and combinations thereof.

While the disclosure has been described with reference to example embodiments, it will be understood by those skilled in the art that a variety of modifications, additions and deletions are within the scope of the disclosure, as defined by the following claims.

Any and all patents and other publications identified in this specification are incorporated by reference as though fully set forth herein.

What is claimed is:

1. A method for producing contact lenses, comprising the steps of:
(1) obtaining a preformed contact lens precursor that is made of a first crosslinked polymeric material and comprises a front surface and a back surface opposite the front surface, wherein one of the front surface and the back surface is a recess-containing surface comprising one or more recesses each of which has side walls, a bottom surface, a depth of between about 0.5 micron and about 30 microns, and a width or length of greater than about 2.0 mm;
(2) accurately and uniformly applying a polymerizable composition to the one or more recesses to fully cover each recess with a layer of the polymerizable composition in a way that a top surface of the layer merges with the recess-containing surface and has a curvature substantially identical to the curvature of the recess-containing surface; and
(3) curing actinically or thermally the polymerizable composition in the recesses to form a contact lens comprising thin objects that are made of a second crosslinked polymeric material and has a thickness of between about 0.5 micron and about 30 microns and a width or length of greater than about 2.0 millimeters, wherein each thin object is partially embedded in the contact lens and comprises a buried surface and an exposed surface opposite the buried surface, wherein the buried surface is in contact directly with the first crosslinked polymeric material whereas the exposed surface merges with an anterior surface or a posterior surface of the contact lens and has a curvature substantially identical to the curvature of the anterior surface or the posterior surface of the contact lens.

2. The method of claim 1, wherein the method further comprises, between steps (2) and (3), a step of placing and pressing a capping mold half onto the recess-containing surface comprising the one or more recesses filled with the polymerizable composition therein.

3. The method of claim 2, wherein the preformed contact lens precursor is obtained by:
dispensing a lens formulation into a mold assembly, the mold assembly comprising a bottom mold portion with a first molding surface and a top mold portion with a second molding surface, wherein a molding cavity for holding the lens formulation is formed between the first and second molding surfaces when the bottom mold portion and the top mold portion are mated and pressed tightly together, wherein one of the first and second molding surfaces comprises one or more raised portions which conform to the recesses in the preformed contact lens precursor; and
curing actinically or thermally the lens formulation to form the preformed contact lens precursor.

4. The method of claim 1, wherein the first molding surface comprises the one or more raised portions which conform to the recesses in the preformed contact lens precursor.

5. The method of claim 1, wherein the second molding surface comprises the one or more raised portions which conform to the recesses in the preformed contact lens precursor.

6. The method of claim 1, wherein accurately and uniformly applying the polymerizable composition to the one or more recessed areas comprises moving a motion control platform along at least one axis to precisely control application of the polymerizable composition via an ultrasonic nozzle dispenser.

7. The method of claim 1, wherein the preformed contact lens precursor comprises a series of recesses arranged in a ring outside of the optical zone of the recess-containing surface, wherein each recess has a shape of a circle, an oval, a polygon.

8. The method of claim 1, wherein the preformed contact lens precursor comprises a circular recess which is concentric with central axis of the preformed contact lens precursor and has a diameter of from about 2.0 mm to about 10.0 mm.

9. The method of claim 8, wherein the bottom surface of the recess comprises a diffractive structure for providing multifocal power, wherein the polymerizable composition comprises at least one aryl vinylic monomer and/or at least one aryl vinylic crosslinker together in an amount sufficient to impart the second crosslinked polymeric material with a refractive index which is at least 0.03 higher than the refractive index of the first crosslinked polymeric material.

10. The method of claim 1, wherein the front surface of the preformed contact lens precursor is the recess-containing surface, and/or wherein the back surface of the preformed contact lens precursor is the recess-containing surface.

11. A contact lens that comprises a lens body comprising: an anterior surface, a posterior surface opposite the anterior surface, a bulk hydrogel material, and one or more thin plastic objects partially embedded in the bulk hydrogel material, wherein the thin plastic objects are made of a crosslinked polymeric material different from the bulk hydrogel material and has a thickness of between about 0.5 micron and about 30 microns and a width or length of greater than about 2.0 mm, wherein each thin plastic object comprises a buried surface and an exposed surface opposite the buried surface, wherein the buried surface is in contact directly with the bulk hydrogel material whereas the exposed surface merges with the anterior surface or the posterior surface of the contact lens and has a curvature substantially identical to the curvature of the anterior surface or the posterior surface of the contact lens.

12. The contact lens of claim 11, wherein the lens body comprises a series of thin plastic objects arranged in a ring outside of the optical zone of the anterior or posterior surface, wherein each think plastic object has a shape of a circle, an oval, a polygon.

13. The contact lens of claim 11, wherein the lens body comprises one circular thin plastic object which is concentric with central axis of the contact lens and has a diameter of from about 2.0 mm to about 10.0 mm.

14. The contact lens of claim 13, wherein the buried surface of the thin plastic object comprises a diffractive structure for providing multifocal power, wherein the crosslinked polymeric material has a refractive index which is at least 0.03 higher than the refractive index of the first crosslinked polymeric material, wherein the crosslinked polymeric material comprises aryl-containing repeating units of at least one aryl vinylic monomer and/or at least one aryl vinylic crosslinker.

15. The contact lens of claim 13, wherein the crosslinked polymeric material comprises: repeating units of at least one HEVL-absorbing vinylic monomer, at least one photochromic compound, at least one anti-reflective material, at least one dyes capable of selectively filtering a color light, or combinations thereof.

16. The contact lens of claim 13, wherein the exposed surface of each of the one or more thin plastic objects merges with the anterior or posterior surface of the contact lens and has a curvature substantially identical to the curvature of the anterior surface of the contact lens.

17. The contact lens of claim 16, wherein the bulk hydrogel material is a non-silicone hydrogel material which comprises (a) repeating units of at least hydrophilic vinylic monomer selected from the group consisting of a hydroxyl-containing acrylic monomer, N-vinyl amide monomer, a methylene-containing pyrrolidone monomer, and combinations thereof and (b) repeating units of at least polymerizable component selected from the group consisting of a vinylic crosslinker, a hydrophobic vinylic monomer, a UV-absorbing vinylic monomer, a HEVL-absorbing vinylic monomer, a polymerizable dye, and combinations thereof.

18. The contact lens of claim 12, wherein the bulk hydrogel material is a silicone hydrogel material which comprises (a) repeating units of at least one silicone-containing vinylic monomer and/or at least one polysiloxane vinylic crosslinker, (b) repeating units of at least hydrophilic vinylic monomer, (c) repeating units of at least one polymerizable component selected from the group consisting of at least one non-silicone vinylic crosslinker, at least one UV-absorbing vinylic monomer, at least one HEVL-absorbing vinylic monomer, a polymerizable dye, and combinations thereof.

19. The contact lens of claim 14, wherein the bulk hydrogel material is a silicone hydrogel material which comprises (a) repeating units of at least one silicone-containing vinylic monomer and/or at least one polysiloxane vinylic crosslinker, (b) repeating units of at least hydrophilic vinylic monomer, (c) repeating units of at least one polymerizable component selected from the group consisting of at least one non-silicone vinylic crosslinker, at least one UV-absorbing vinylic monomer, at least one HEVL-absorbing vinylic monomer, a polymerizable dye, and combinations thereof.

20. The contact lens of claim 16, wherein the bulk hydrogel material is a silicone hydrogel material which comprises (a) repeating units of at least one silicone-containing vinylic monomer and/or at least one polysiloxane vinylic crosslinker, (b) repeating units of at least hydrophilic vinylic monomer, (c) repeating units of at least one polymerizable component selected from the group consisting of at least one non-silicone vinylic crosslinker, at least one UV-absorbing vinylic monomer, at least one HEVL-absorbing vinylic monomer, a polymerizable dye, and combinations thereof.
